(19) United States
(12) Patent Application Publication
(10) Pub. No.: US 2016/0364609 A1
(43) Pub. Date: Dec. 15, 2016

(54) APPARATUSES AND METHODS FOR IRIS BASED BIOMETRIC RECOGNITION

(71) Applicant: DELTA ID INC., Fremont, CA (US)

(72) Inventors: ALEXANDER IVANISOV, Newark, CA (US); SALIL PRABHAKAR, Fremont, CA (US)

(21) Appl. No.: 14/738,505

(22) Filed: Jun. 12, 2015

(51) Int. Cl. G06K 9/00; G06K 9/62; G06K 9/46; H04N 7/18

(52) U.S. Cl. CPC G06K 9/00604; H04N 7/181; G06K 9/6201; G06K 9/4604

(57) ABSTRACT

The invention provides apparatuses, methods and computer program products for obtaining and processing images of one or more features of a subject's eye for biometric recognition. The invention comprises receiving a first image of a first image region within a field of view of an imaging apparatus and receiving a second image of a second image region within the field of view of the imaging apparatus. Thereafter it is determined whether image information extracted from the first image matches stored iris information corresponding to at least one iris. Responsive to the first determination rendering a non-match decision, performing a second determination comprising determining whether image information extracted from the second image matches the stored iris information.

### FIELD OF INVENTION

The invention relates to apparatuses and methods for obtaining and processing images of one or more features of a subject's eye for biometric recognition.

### BACKGROUND

Methods for biometric recognition based on facial features, including features of the eye are known. Methods for iris recognition implement pattern-recognition techniques to compare an acquired image of a subject's iris against a previously stored image of the subject's iris, and thereby determine or verify identity of the subject. A digital feature set corresponding to an acquired iris image is encoded based on the image, using mathematical or statistical algorithms. The digital feature set or template is thereafter compared with databases of previously encoded digital templates (stored feature sets corresponding to previously acquired iris images), for locating a match and determining or verifying identity of the subject.

Apparatuses for iris recognition typically comprise an imaging apparatus for capturing an image of the subject's iris(es) and an image processing apparatus for comparing the captured image against previously stored iris image information. The imaging apparatus and image processing apparatus may comprise separate devices, or may be combined within a single device.

While iris recognition apparatuses have been previously available as dedicated or stand alone devices, it is increasingly desirable to incorporate iris recognition capabilities into handheld devices or mobile communication devices or mobile computing devices (collectively referred to as “mobile devices”) having inbuilt cameras, such as for example, mobile phones, smart phones, personal digital assistants, tablets, laptops, or wearable computing devices.

Implementing iris based recognition in mobile devices is convenient and non-invasive and gives individuals access to compact ubiquitous devices capable of acquiring iris images of sufficient quality to enable recognition (identification or verification) of identity of an individual. By incorporating iris imaging apparatuses into mobile devices, such mobile devices achieve biometric recognition capabilities, which capabilities may be put to a variety of uses, including access control for the mobile device itself.

Existing devices and methods for iris recognition may be categorized as single and dual eye recognition devices and methods. In single eye recognition devices and methods, an image sensor acquires and processes an image of a subject's iris and compares the acquired iris image against previously acquired or enrolled iris images. A match or a non-match decision is arrived at based on the results of the comparison. Dual eye recognition devices acquire images of both eyes of a subject, and thereafter compares both of the acquired iris images against previously acquired or enrolled iris images, for arriving at a match or a non-match decision.

While prior art iris imaging systems are capable of being incorporated into mobile devices, the time taken by prior art iris image processing systems to process and compare iris image information against previously stored iris information would be significant—leading to evident time lags between iris image acquisition and recognition (or a refusal to recognize).

The primary underlying cause for time lags is that reliable iris image processing and feature extraction is computationally intensive, making it difficult to process every frame within a sequence of image frames. This is particularly the case, for the reason that state-of-the-art image sensors produce at least 30 frames per second in video mode. A further drawback of attempting to compare every frame within a sequence of image frames produced by an image sensor with the stored template(s) is that too many image comparisons may increase the observed false matches. The incidence of false matches is measured in terms of the false match rate (FMR), or the false positive identification rate (FPIR) of the recognition system under observation.

To overcome the above drawbacks, an automatic image selection process may be implemented. The selection method computes one or more “quality” measurements of each image frame and selects the best frame detected within a predetermined timeframe, or alternatively one or more frames that satisfy predetermined quality criteria. The selected image frame(s) is thereafter subjected to further processing and comparison steps. Existing commercially available iris recognition systems apply automatic image selection methods as a standard approach to reducing time lags.

A quality assessment criterion in prior art systems is sharpness (also called focus) measurement of the image frame. Focus assessment based image selection algorithms have been found to improve efficiencies of an iris recognition system. Computationally efficient image processing methods are typically used to obtain a scalar value for each frame denoting its focus quality and the image frame that exceeds a predetermined focus threshold is selected for further processing and comparison.

In addition to reducing time lags and conserving processing resources, automatic image selection processes are implemented in applications where reference templates (e.g. iris image feature sets stored in a database) may not be readily available at the location of image capture. Commercial deployments of iris based recognition systems in military, civilian, border control, national ID, police, and surveillance applications typically fall within this category. Such applications require the recognition system to store, transmit or forward the automatically selected image frame, which frame is compared against referenced templates at a later time or at a different location. For example, in a military application, the selected (“captured”) image or extracted feature set may be sent from a foreign country to a central server in home country for comparison. In another example, in a national ID system (such as the ID system presently implemented by the Unique Identification Authority of India), the captured image is sent over to a server farm to be de-duplicated against all previously enrolled subjects.

Despite the above, there are disadvantages to using the automatic image selection process—for the reason that a quality measurement algorithms does not always predict an image frame's match-ability accurately enough. For example, it has been found that rejecting 10% lowest quality images in a database only improves the false non match rate (FNMR) from 10% to 7%. This is acknowledged as presenting a poor trade-off and confirms that quality assessment algorithms are not sufficiently accurate predictors of match-ability. It is therefore preferable that application of iris based recognition systems within mobile devices, and systems where reference templates are readily available, should not be subjected to the drawbacks that the automatic image selection process imposes. Similarly it is preferable that quality assessment related drawbacks be avoided in certain client-server type iris recognition systems, where reference templates can be pulled from a central server to a local client where the iris imaging occurs.

Additionally, the invention seeks to achieve more efficient image quality assessment and image processing, using specifically configured eye recognition devices.

### SUMMARY

The invention provides a method for iris based biometric recognition. In an embodiment, the method comprises the steps of (a) receiving an image from an image sensor (b) determining whether the received image includes an iris (c) repeating steps (a) and (b) until the received image includes an iris (d) responsive to determining that a received image includes an iris, comparing iris information corresponding to such received image with stored iris information corresponding to at least one iris and (e) rendering a match decision or a non-match decision based on an output of the comparison.

The comparison at step (d) of the invention may comprise comparing an iris feature set generated by feature extraction performed on the received iris image, with the stored iris information. In an embodiment, steps (a) to (e) may be repeated until occurrence of a termination event, which termination event may comprise any of (i) expiry of a predetermined time interval, or (ii) comparison of a predetermined number of received iris images, or (iii) rendering of a match decision based on comparison between iris information corresponding to a received iris image and the stored iris information, or (iv) distance between the image sensor and the subject exceeding a predetermined maximum distance, or (v) a determination that a received image does not include an iris.

In an exemplary implementation of the invention, a match decision may be rendered responsive to the acquired iris image satisfying a predetermined degree of similarity with stored iris information corresponding to at least one iris.

In an embodiment of the method of the present invention, image subsampling may be performed on an image received at step (a), to generate a subsampled image and in which case, the determination at step (b) may comprise an examination of the subsampled image.

The invention may additionally provides a method for iris based biometric recognition, comprising the steps of (a) receiving an image from an image sensor, wherein the received image includes an iris image (b) determining whether the received iris image satisfies at least one predetermined criteria (c) repeating steps (a) and (b) until the received iris image satisfies at least one predetermined criteria (d) responsive to determining that the received iris image satisfies at least one predetermined criteria, comparing iris information corresponding to such received iris image with stored iris information corresponding to at least one iris and (e) rendering a match or non-match decision based on output of the comparison. The predetermined criteria may comprise at least one of (i) grayscale spread (ii) iris size (iii) dilation (iv) usable iris area (v) iris-sclera contrast (vi) iris-pupil contrast (vii) iris shape (viii) pupil shape (ix) image margins (x) image sharpness (xi) motion blur (xii) signal to noise ratio (xiii) gaze angle (xiv) scalar score (xv) a minimum time interval separating the received iris image from one or more iris images previously taken up for comparison (xvi) a minimum number of sequentially generated iris images separating the received iris image from one or more iris images previously taken up for comparison and (xvii) a minimum difference between the received iris image and one or more iris images previously taken up for comparison.

In a particular embodiment of the above method, the comparison at step (d) may comprise a comparison between an iris feature set generated by feature extraction performed on the received iris image, and the stored iris information. In an embodiment, steps (a) to (e) may be repeated until occurrence of a termination event, which termination event may comprise any of (i) expiry of a predetermined time interval, or (ii) conclusion of comparison of a predetermined number of received iris images, or (iii) rendering of a match decision based on comparison between iris information corresponding to a received iris image and the stored iris information or (iv) distance between the image sensor and the subject exceeding a predetermined maximum distance.

In accordance with a specific implementation of the method, a match decision may be rendered responsive to the received iris image satisfying a predetermined degree of similarity with stored iris information corresponding to at least one iris.

In a particular embodiment of the inventive method, image subsampling may be performed on the image received at step (a) to generate a subsampled image, and the determination at step (b) whether the received iris image satisfies at least one predetermined criteria, is based on the subsampled image.

The invention may additionally provides a method for iris based biometric recognition, comprising the steps of (a) receiving an image from an image sensor, wherein the image includes an iris image, (b) performing a first set of comparison operations by comparing iris information corresponding to the received iris image with stored iris image information corresponding to at least one iris (c) responsive to output of step (b) satisfying a specified outcome, performing a second set of comparison operations by comparing iris information corresponding to the received iris image with the stored iris image information, and (d) rendering a match decision or a non-match decision based on output of the second set of comparison operations at step (c).

In an embodiment of this method, the second set of comparison operations at step (c) compares iris information corresponding to the received iris image with such stored iris image information, which at step (b) has generated an output satisfying the specified outcome.

In an implementation of the above method, the specified outcome may comprise (i) a match between the received iris image and stored iris image information corresponding to at least one iris or (ii) a predetermined degree of similarity between the received iris image and stored iris image information corresponding to at least one iris. In another implementation, the specified outcome may comprise (i) a non-match between the received iris image and stored iris image information corresponding to at least one iris or (ii) less than a predetermined degree of similarity between the received iris image and stored iris image information corresponding to at least one iris.

In an embodiment of the method, at least one operation within the second set of comparison operations is not included within the first set of comparison operations. In another embodiment, at least one of the first set of comparison operations and the second set of comparison operations includes feature extraction operations for extracting an iris feature set from the received iris image.

The first set of comparison operations may include a first set of feature extraction operations and the second set of comparison operations may include a second set of feature extraction operations, such that at least one operation within the second set of feature extraction operations is not included within the first set of feature extraction operations.

In accordance with an embodiment of the above method, steps (a) to (d) may be repeated until (i) determination of a match between the received iris image and stored iris image information corresponding to at least one iris or (ii) the received iris image satisfies a predetermined degree of similarity with stored iris image information corresponding to at least one iris. In another embodiment, steps (a) to (d) may be repeated until occurrence of a termination event, which termination event may comprise any of (i) expiry of a predetermined time interval, or (ii) comparison of a predetermined number of received images, or (iii) distance between the image sensor and the subject exceeding a predetermined maximum distance or (iv) a determination that a received image does not include an iris.

The method may comprise the step of image subsampling performed on the image received at step (a) to generate a subsampled image, wherein the first set of comparison operations at step (b) is performed on the subsampled image. In a more specific embodiment, image data on which the second set of comparison operations is performed at step (c) has not been reduced by image subsampling.

The invention may additionally provides a method for iris based biometric recognition, comprising the steps of (a) initializing sequential generation of image frames by an image sensor (b) selecting an image frame generated by the image sensor (c) comparing image information corresponding to the selected image frame with stored iris image information corresponding to at least one iris image and (d) responsive to the comparison at step (c) rendering a non-match decision, selecting another image frame generated by the image sensor and repeating steps (c) and (d), the selection of another image frame being based on a predetermined criteria, wherein the predetermined criteria comprises at least one of (i) availability of a resource to perform image processing or comparison, or (ii) elapse of a specified time interval since occurrence of a defined event corresponding to a previously selected image frame, or (iii) a specified number of sequentially generated image frames separating a previously selected image frame and an image frame being considered for selection, or (iv) a minimum difference between a previously selected image frame and an image frame being considered for selection.

In an embodiment of the above method, the comparison at step (c) is preceded by a step of performing feature extraction on the first image for extracting an iris feature set of an imaged iris within the first image, and the comparison at step (c) comprises comparing the extracted iris feature set with the stored iris image information.

The invention may additionally comprise a method for iris based biometric recognition, comprising the steps of (a) receiving a first image of a first image region within a field of view of an imaging apparatus, (b) receiving a second image of a second image region within the field of view of the imaging apparatus, (c) performing a first determination comprising determining whether image information extracted from the first image matches stored iris information corresponding to at least one iris, and (d) responsive to the first determination rendering a non-match decision, performing a second determination comprising determining whether image information extracted from the second image matches the stored iris information.

In an embodiment, this method may comprise responding to the second determination rendering a non-match decision in comparison with the stored iris information by combining outputs of the first determination and the second determination based on a method for combining outputs and rendering a match decision or a non-match decision based on an output of the combining of outputs.

In another embodiment, the first image region and the second image region may be positioned to partially overlap each other. Further, in this embodiment, the overlap between the first image region and the second image region may define a common overlap region having horizontal width of at least 300 pixels. Alternatively, the overlap between the first image region and the second image region may define a common overlap region such that horizontal width of the common overlap region is of a dimension sufficient to fully accommodate an iris positioned within the common overlap region at an object plane located within a depth of field of the imaging apparatus. In a more specific embodiment of this invention, the object plane may be located at a shortest image capture distance defined by the depth of field of the imaging apparatus.

The invention also provides a further method for iris based biometric recognition comprising the steps of (a) receiving an image from an image sensor of an imaging apparatus, (b) accumulating evidence in support of similarity and/or dissimilarity of the iris information from the image in step (a) in comparison with at least one stored iris template; and (c) repeating steps (a) and (b) until sufficient evidence is accumulated to support or generate either a match decision or a non-match decision with reference to at least one stored iris template or until occurrence of a termination event.

The invention additionally provides systems and computer program products configured to implement the systems and methods described above and in further detail throughout the specification.

An embodiment of the invention comprises a computer program product for iris based biometric recognition, which computer program product comprises a computer usable medium having a computer readable program code embodied therein, the computer readable program code comprising instructions for (a) receiving an image from an image sensor (b) determining whether the received image includes an iris (c) repeating steps (a) and (b) until the received image includes an iris (d) responsive to determining that a received image satisfies at least one predetermined criteria, comparing iris information corresponding to such received image with stored iris information corresponding to at least one iris and (e) rendering a match decision or a non-match decision based on an output of the comparison.

The invention additionally provides a computer program product for iris based biometric recognition, comprising a computer usable medium having a computer readable program code embodied therein, the computer readable program code comprising instructions for (a) receiving a first image of a first image region within a field of view of an imaging apparatus, (b) receiving a second image of a second image region within the field of view of the imaging apparatus, (c) performing a first determination comprising determining whether image information extracted from the first image matches stored iris information corresponding to at least one iris, and (d) responsive to the first determination rendering a non-match decision, performing a second determination comprising determining whether image information extracted from the second image matches the stored iris information.

Another embodiment of the invention comprises a system for iris based biometric recognition, comprising an image sensor, and a processing device configured for (a) receiving an image from an image sensor (b) determining whether the received image includes an iris (c) repeating steps (a) and (b) until the received image includes an iris (d) responsive to determining that a received image satisfies at least one predetermined criteria, comparing iris information corresponding to such received image with stored iris information corresponding to at least one iris and (e) rendering a match decision or a non-match decision based on an output of the comparison.

The invention additionally provides a system for iris based biometric recognition, comprising at least one image sensor, and a processing device configured for (a) receiving a first image of a first image region within a field of view of an imaging apparatus, (b) receiving a second image of a second image region within the field of view of the imaging apparatus, (c) performing a first determination comprising determining whether image information extracted from the first image matches stored iris information corresponding to at least one iris, and (d) responsive to the first determination rendering a non-match decision, performing a second determination comprising determining whether image information extracted from the second image matches the stored iris information.

### BRIEF DESCRIPTION OF THE ACCOMPANYING DRAWINGS

FIG. 1 is a functional block diagram of an apparatus configured for iris image based recognition.

FIG. 2 illustrates an exemplary embodiment of an imaging apparatus.

FIG. 3 illustrates steps involved in iris image based recognition systems.

FIGS. 4 to 7 are flowcharts illustrating methods for iris image based recognition according to the present invention.

FIG. 8 illustrates an implementation of the method for iris image based recognition according to the present invention.

FIG. 9 is a flowchart illustrating a method for iris image based recognition according to the present invention.

FIG. 10 illustrates a top view of an iris imaging apparatus.

FIGS. 11 and 13 to 16 are flowcharts illustrating method embodiments of the present invention.

FIGS. 12A to 12C illustrate exemplary image frames for processing in accordance with embodiments of the invention.

FIG. 17 illustrates an exemplary configuration of an imagine apparatus having overlapping first and second image regions within a field of view.

FIG. 18 illustrates an exemplary computer system in which various embodiments of the invention may be implemented.

### DETAILED DESCRIPTION

The present invention is directed to apparatuses and methods configured for biometric recognition based on iris imaging and processing. In an embodiment, the apparatus of the present invention comprises a mobile device having an iris based recognition system implemented therein.

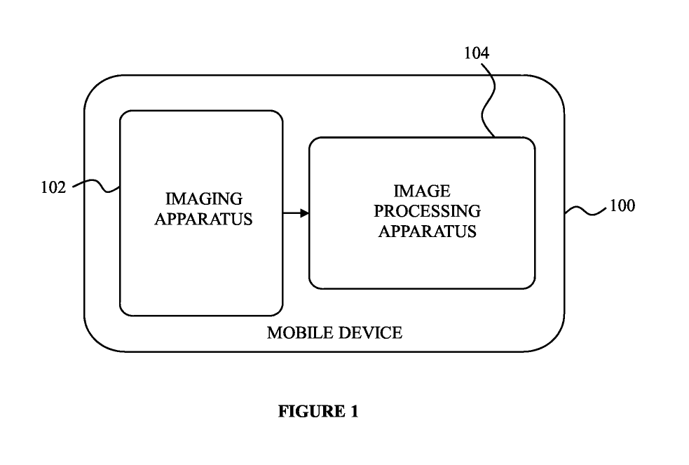

FIG. 1 is a functional block diagram of a mobile device 100 configured for iris image based recognition, comprising an imaging apparatus 102 and an image processing apparatus 104. Imaging apparatus 102 acquires an image of the subject's iris and transmits the image to image processing apparatus 104. The image captured by imaging apparatus 102 may be a still image or a video image. Image processing apparatus 104 thereafter analyses the acquired image frame(s) and compares the corresponding digital feature set with digital templates encoded and stored based on previously acquired iris images, to identify the subject, or to verify the identity of the subject.

Although not illustrated in FIG. 1, mobile device 100 may include other components, including for extracting still frames from video images, for processing and digitizing image data, for enrolment of iris images (the process of capturing, and storing iris information for a subject, and associating the stored information with that subject) and comparison (the process of comparing iris information acquired from a subject against information previously acquired during enrolment, for identification or verification of the subject's identity), and for enabling communication between components of the mobile device. The imaging apparatus, image processing apparatus and other components of the mobile device may each comprise separate devices, or may be combined within a single mobile device.

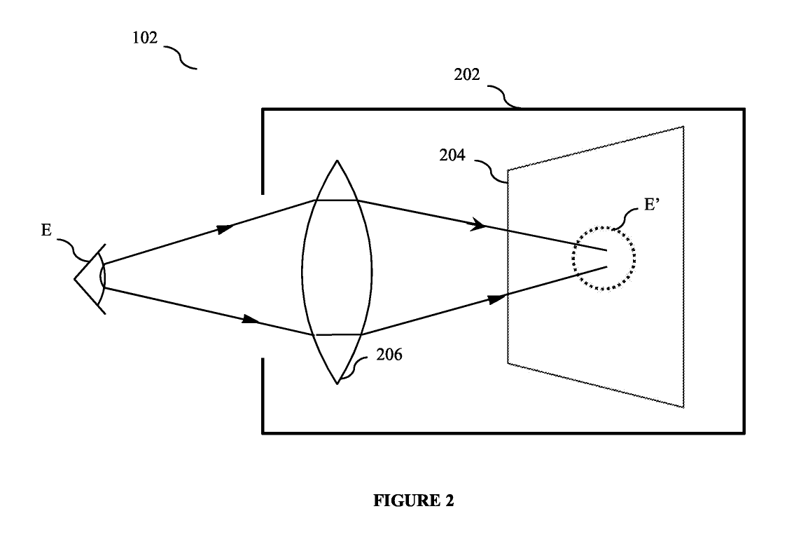

FIG. 2 illustrates an exemplary embodiment of imaging apparatus 102 having housing 202, image sensor 204 and an optical assembly 206, wherein image sensor 204 and optical assembly 206 are disposed within the housing 202.

Imaging apparatus 102 may comprise a conventional solid state still camera or video camera, and image sensor 204 may comprise a charged coupled device (CCD) or a complementary metal oxide semiconductor (CMOS) device. Image sensor 204 may be selected for sensitivity at least to light having wavelengths anywhere in the range of 400 nanometres to 1000 nanometres. Optical assembly 206 may comprise a single unitarily formed element, or may comprise an assembly of optical elements selected and configured for achieving desired image forming properties. The imaging apparatus may have a fixed focus, or a variable focus achieved using any of several prevalent technologies (e.g. a voice coil motor).

As illustrated in FIG. 2, optical assembly 206 and image sensor 204 may be configured and disposed relative to each other, such that (i) one surface of image sensor 204 coincides with the image plane of optical assembly 206 and (ii) the object plane of optical assembly 206 coincides with an intended position or a subject's eye E for iris image acquisition. Accordingly as illustrated, when subject's eye E is positioned at the object plane, an in-focus image E′ of the eye is formed on image sensor 204.

The imaging apparatus may additionally comprise an illuminator (not illustrated) used to illuminate the iris of the subject being identified. The illuminator may emit radiations having wavelengths falling within the range of 400 nanometres to 1000 nanometres, and in an embodiment specifically configured for iris based image recognition, may emit radiations having wavelengths between 700 nanometres and 900 nanometres. The illuminator may comprise any source of illumination including an incandescent light or a light emitting diode (LED).

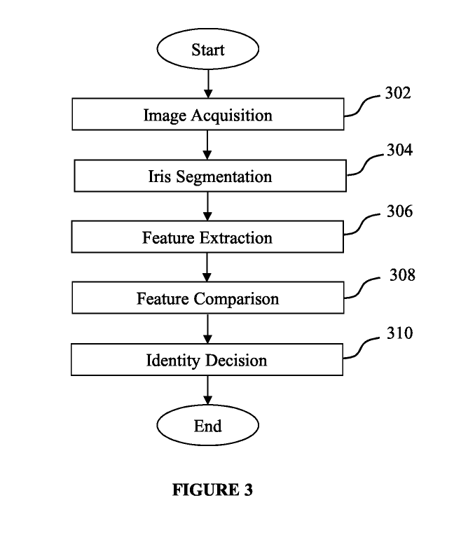

FIG. 3 illustrates steps typically involved in iris image based recognition systems. At step 302, the imaging apparatus acquires an image of the subject's iris.

Iris segmentation is performed on the acquired image at step 304. Iris segmentation refers to the step of locating the inner and outer boundaries of the iris within the acquired image, and cropping the portion of the image which corresponds to the iris. Since the iris is annular in shape, iris segmentation typically involves identifying two substantially concentric circular boundaries within the acquired image—which circular boundaries correspond to the inner and outer boundaries of the iris. Several techniques for iris segmentation may be implemented to this end, including for example Daugman's iris segmentation algorithm. Iris segmentation may additionally include cropping of eyelids and eye lashes from the acquired image. It would be understood that iris segmentation is an optional step prior to feature extraction and comparison that may be avoided entirely. Iris segmentation is at times understood to comprise a part of feature extraction operations, and is not always described separately.

Subsequently, feature extraction is performed at step 306—comprising processing image data corresponding to the cropped iris image, to extract and encode salient and discriminatory features that represent an underlying biometric trait. For iris images, features may be extracted by applying digital filters to examine texture of the segmented iris images. Application of digital filters may result in a binarized output (also referred to as an “iris code” or “feature set”) comprising a representation of salient and discriminatory features of the iris. Multiple techniques for iris feature extraction may be implemented, including by way of example, application of Gabor filters.

At step 308, a comparison algorithm compares the feature set corresponding to the acquired iris image against previously stored iris image templates from a database, to generate scores that represent a difference (i.e. degree of similarity or dissimilarity) between the input image and the database templates. The comparison algorithm may for example involve calculation of a hamming distance between the features sets of two iris images, wherein the calculated normalized hamming distance represents a measure of dissimilarity between two irises.

The feature extraction and comparison steps may be integrated into a single step. Equally, the feature extraction step may be omitted entirely, in which case the comparison step may comprise comparing iris image information corresponding to the received frame, with stored iris information corresponding to at least one iris image. For the purposes of this invention, any references to the step of comparison shall be understood to apply equally to (i) comparison between a feature set derived from a feature extraction step and stored iris image templates, and (ii) comparison performed by comparing iris image information corresponding to the received frame, with stored iris information corresponding to at least one iris image.

At step 310, results of the comparison step are used to arrive at a decision (identity decision) regarding identity of the acquired iris image.

For the purposes of this specification, an identity decision may comprise either a positive decision or a negative decision. A positive decision (a “match” or “match decision”) comprises a determination that the acquired iris image (i) matches an iris image or iris template already registered or enrolled within the system or (ii) satisfies a predetermined degree of similarity with an iris image or iris template already registered or enrolled within the system. A negative decision (a “non-match” or “non-match decision”) comprises a determination that the acquired iris image (i) does not match any iris image or iris template already registered or enrolled within the system or (ii) does not satisfy a predetermined degree of similarity with any iris image or iris template registered or enrolled within the system. In embodiments where a match (or a non-match) relies on satisfaction (or failure to satisfy) a predetermined degree of similarity with iris images or iris templates registered or enrolled within the system—the predetermined degree of similarity may be varied depending on the application and requirements for accuracy. In certain devices (e.g. mobile devices) validation of an identity could result in unlocking of, access authorization or consent for the mobile device or its communications, while failure to recognize an iris image could result in refusal to unlock or refusal to allow access. In an embodiment of the invention, the match (or non-match) determination may be communicated to another device or apparatus which may be configured to authorize or deny a transaction, or to authorize or deny access to a device, apparatus, premises or information, in response to the communicated determination.

Of the stages involved in iris based recognition systems, it has been found that precise iris segmentation and feature extraction are particularly resource intensive (in comparison to the remaining stages) and requires more processing time and resources than the other stages. In view of existing processing capabilities presently associated with iris based imaging and processing apparatuses, and in view of known processing capabilities of existing mobile devices, the processing steps required for segmentation and feature extraction has been found to be a significant causative factor insofar as delays and time lags observed in iris recognition systems are concerned.

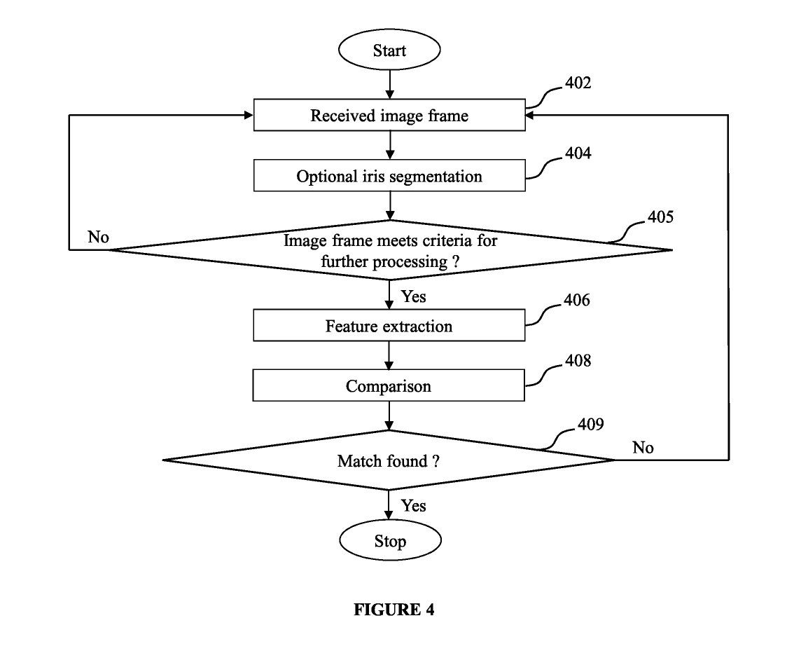

FIG. 4 is a flowchart illustrating a method for iris based recognition according to the present invention. The method commences at step 402 by receiving an image frame from an image sensor. The image frame may have been acquired by the image sensor in response to an actuation instruction to capture at least one image frame. The image sensor may be configured to either (i) respond to an actuation instruction by capturing a single image frame (single frame image capture mode) or (ii) respond to an actuation instruction by capturing a sequence of image frames acquired at the image sensor's video frame rate (video image capture mode).

At step 404, one or both of iris segmentation and image subsampling is performed on the received image frame. Iris segmentation may include one or both of (i) determining whether the received image frame includes an iris image and (ii) isolating an imaged iris within the image frame. Image subsampling refers to the process of reducing image sampling resolution of an image frame—and may be performed to reduce the number of data bits required to represent the image frame. In an embodiment of the method of FIG. 4, one or both of iris segmentation and image subsampling may be entirely omitted, or may be integrated or subsumed into any other step of the method.

Step 405 comprises a determination whether any one or more of the received image frame or a derivative subsampled image frame, or image information derived from the received image frame, meets a predetermined criteria for further processing—which further processing may include feature extraction or comparison or both. The predetermined criteria at step 405 may be defined in terms of one or more of the following attributes of an image frame under assessment: (i) grayscale spread (ii) iris size (iii) dilation (iv) usable iris area (v) iris-sclera contrast (vi) iris-pupil contrast (vii) iris shape (viii) pupil shape (ix) image margins (x) image sharpness (xi) motion blur (xii) signal to noise ratio (xiii) gaze angle (xiv) scalar score (xv) a minimum time interval separating generation or receipt of an image frame under consideration for further processing and an image frame previously taken up for further processing (xvi) a minimum number of sequentially generated image frames that are required to separate two image frames that are consecutively taken up for further processing and (xvii) difference (degree of similarity or dissimilarity) between an image frame under consideration for further processing and an image frame previously taken up for further processing. Each of the above factors for assessment is described in further detail below.

In the event the image frame does not meet the predetermined criteria for further processing, the method does not proceed to the step of feature extraction, and instead reverts to step 402 to receive another image frame from the image sensor. If on the other hand, the image frame acquired at step 402 meets the predetermined criteria, the method performs feature extraction on the image frame at step 406. Feature extraction at step 406 may be performed either on unaltered image data corresponding to the image frame as received at step 402. Alternatively, in cases where the received image frame has been subjected to the steps of iris segmentation and/or image subsampling at step 404, feature extraction may be performed on the output image data arising from the steps of iris segmentation and/or image subsampling. Yet alternatively, output image data arising from the steps of iris segmentation and/or image subsampling may be used only for determining whether an image frame meets a predetermined criteria for further processing (at step 405), while the step of feature extraction (at step 406) for image frames found to meet the predetermined criteria may be performed on image frame data that has not been reduced either by iris segmentation or by image subsampling.

At step 408, comparison is performed on the iris feature set resulting from feature extraction step 406. The comparison step may comprise comparing the extracted iris feature set with stored iris information corresponding to at least one iris image. At step 409, if based on the comparison, a match is found, the method may terminate, otherwise, the method may loop back to step 402 for the next image frame. The feature extraction and comparison steps may be integrated into a single step. Equally, the feature extraction may be omitted entirely, in which case the comparison step may comprise comparing iris image information corresponding to the received frame, with stored iris information corresponding to at least one iris image.

It would be understood that the looping at step 409 of FIG. 4 is optional, and a variant of the method of FIG. 4 may be performed by searching for a match based on a fixed number of acquired image frames, or by terminating the method after performing comparison on image frames (i) for a fixed period of time (i.e. until the method times out) or (ii) until any time after a match found has been rendered or (iii) until cancelled, timeout, or otherwise stopped without match found. In an embodiment, the method may be terminated upon a sensor based determination that the distance between the imaging sensor (or the imaging apparatus or the device housing such apparatus or sensor) and the subject has exceeded a predetermined maximum distance. Sensor's capable of such determination include proximity sensors, such as capacitive sensors, capacitive displacement sensors, Doppler effect sensors, eddy-current sensors, inductive sensors, laser rangefinder sensors, magnetic sensors (including magnetic proximity sensors), passive optical sensors (including charge-coupled devices), thermal infrared sensors, reflective photocell sensors, radar sensors, reflection based sensors, sonar based sensors or ultrasonic based sensors. In another embodiment, the method may be terminated (i) if an eye that was present in preceding image frames is found to be absent in a subsequent image frames or (ii) if a size of the eye in subsequent image frames is found to decrease—indicating that the iris imaging device is being removed from the vicinity of the eye.

Similarly, at step 405, if the acquired image frame does not meet a predetermined criteria for further processing, the method may simply terminate without reverting to step 402 for receiving another image frame.

The modalities of acquiring a second (and each subsequent) image frame at step 402 may depend on whether the image processing apparatus is in single frame image capture mode or in video image capture mode. In single frame image capture mode, successive image frame would only be obtained at step 402 in response to repeated actuations of the image sensor by an operator or other means. In video image capture mode, the image sensor captures a sequence of successive image frames in response to a single actuation, and a next image frame may be obtained at step 402 from among the successive image frames within the captured sequence of image frames. In various embodiments, successive image frames may be obtained from the image sensor (i) until the entire set of image frames generated by the image sensor have been exhausted, or (ii) until a predetermined number of image frames have been received from the image sensor, or (iii) until a predetermined point in time or (iv) until a predetermined criteria is met.

By selectively discarding image frames that do not meet a predetermined criteria prior to an extraction step and/or a comparison step, the method reduces the number of non-productive processing steps, thereby improving response times, and power consumption and preventing false positives from images that do not contain iris.

As described in connection with step 405, the predetermined criteria at step 405 may be defined in terms of one or more of any one of the following factors.

Grayscale spread—grayscale spread measures the spread of intensity values in an image. Image frames having a wide, well-distributed spread of intensity values indicates a properly exposed image. Assessment of grayscale spread of an image frame accordingly presents a qualitative measure of image frame exposure.

Iris size—iris size is measured in terms of a number of pixels across the iris radius, where a circle approximates the iris boundary. Iris size is a function of spatial sampling rate in the object space. By specifying a threshold iris size for further processing, the method eliminates image frames where the iris image does not offer sufficient textural information for accurate extraction and comparison.

Dilation—dilation may be defined as the ratio of pupil diameter to iris diameter. The degree of dilation can change textural content of an imaged iris. By defining a predetermined threshold or range of values for iris image acquisition, the method ensures that the iris image under assessment and previously enrolled iris templates are of comparable dilation and thereby improving the accuracy of the recognition system.

Usable iris area—usable iris area is measured as the percentage of iris that is not occluded by eyelash(es), eyelid(s), specular reflects, ambient specular reflections or otherwise. Occlusion of the iris not only reduces the available iris textural information for comparison, but also decreases accuracy of the iris segmentation process, both of which increase recognition errors. Defining threshold values for usable iris area serves to eliminate image frames that are likely to result in recognition errors.

Iris-sclera contrast—Insufficient iris—sclera contrast may affect the accuracy of iris segmentation and feature extraction processes. The iris-sclera contrast of an image frame under assessment may therefore comprise a predefined criterion for elimination of an image frame without proceeding to feature extraction and comparison.

Iris-pupil contrast—Iris-pupil contrast measures image characteristics at the boundary region between the iris region and the pupil. Low iris-pupil contrast may affect segmentation or degrade accuracy of feature extraction operations. Iris-pupil contrast may therefore serve as a predetermined criterion for image frame elimination without further processing.

Iris shape—iris shape is defined as the shape of the iris-sclera boundary. While iris shape may be a consequence of anatomical variation, it may also be caused by subject behavior such as non-frontal gaze. Iris shape as a predetermined criterion for image frame assessment therefore provides basis for elimination of image frames where the iris shape may have been affected by subject behavior during image capture.

Pupil shape—Iris portions in the immediate vicinity of the pupil offer high information content. Accurate detection of the iris-pupil boundary is accordingly of importance and pupil shape provides a predetermined criterion for image frame assessment and for elimination of image frames where the pupil shape may have been affected by subject behavior during image capture. Pupil shape as a predetermined criterion for image assessment may alternatively provide a basis for choosing between alternate feature extraction and comparison operations for implementation on an image frame.

Margin—Margin refers to the distances of the outer iris boundary from the four image frame boundaries (top, bottom, left and right). Insufficient image margins present difficulties for feature extraction. Image margins may therefore be used a criterion for eliminating image frames without further processing.

Image sharpness—Image sharpness comprises a measure of defocus blur observed in an image frame. Defocus blur is generally observed when an object (e.g. an iris) is outside the depth of field of the camera. Image sharpness may therefore be used as a criterion for eliminating image frames without further processing.

Motion blur—motion blur arises from motion of the camera, or of the object or both, and increases the likelihood of errors in iris recognition. In a handheld device, motion blur may be caused or contributed to by motion of the object or by hand jitter. The degree of motion blur in an image frame may therefore be used as a criterion for eliminating unsuitable image frames without feature extraction and comparison.

Signal to noise ratio—Signal to noise ratio of an image frame provides a determinant of suitability for feature extraction and comparison. In an exemplary implementation, image signal-to-noise ratio may be required to be greater than or equal to 40 dB, inclusive of noise introduced by image compression techniques.

Gaze angle—Gaze angle of an iris image is a measure of deviation between the subject's optical axis and the camera's optical axis. Imaging of the iris when off-axis is found to create a projective deformation of the iris, which affects accuracy of feature extraction and comparison operations. A predefined threshold for permissible gaze angle serves to eliminate unsuitable image frames.

Scalar scores—Certain attributes of an image frame may be determined by image processing to be predictive of its match-ability and represented as a scalar score. A predefined threshold for permissible score serves to eliminate unsuitable image frames.

Time interval separating generation or receipt of an image frame under consideration for further processing and an image frame previously taken up for further processing—a predefined time interval may serve to separate a previous image frame that is taken up for feature extraction and/or comparison (or any other image processing step) and a next image frame that may be taken up for feature extraction and/or comparison (or any other image processing step). The time interval may be assessed based on time of generation of image frames (at the image sensor) or time of receipt of image frames at a processor for processing. For example, an image frame may be taken up for extraction and/or comparison (or any other image processing step) every 100 milliseconds. The time intervals between successive pairs of image frames taken up for extraction and/or comparison (or any other image processing step) may be uniform (i.e. the same for all pairs of image frames) or non-uniform (i.e. may vary across different pairs of image frames).

Number of sequentially generated image frames separating two image frames consecutively taken up for further processing—a predefined number of sequentially generated image frames (intermediate frames) may be required to separate two image frames that are consecutively taken up for feature extraction and/or comparison (or any other image processing step). The predetermined number of intermediate frames between successive pairs of image frames taken up for extraction and/or comparison (or any other image processing step) may be uniform (i.e. the same for all pairs of image frames) or non-uniform (i.e. may vary across different pairs of image frames).

Similarity or dissimilarity between an image frame under consideration for further processing and one or more image frames previously taken up for further processing—selection of image frames successively taken up for feature extraction and/or comparison (or any other image processing step) may be based on a minimum or maximum (or both a minimum and a maximum) threshold difference between the current image frame and one or more previous image frames taken up for feature extraction and/or comparison (or any other image processing step). By implementing a minimum threshold for differences between the current image frame and one or more frames previously taken up for feature extraction and/or comparison (or any other image processing step), the invention ensures that each image frame selected for further processing has perceptible differences compared to the earlier processed image frame—which avoids redundant processing on nearly identical frames. By implementing a maximum threshold for differences between the current image frame and one or more frames previously taken up for feature extraction and/or comparison (or any other image processing step), the invention ensures that each image frame selected for further processing is not substantially different as compared to the earlier processed image frame which improves the likelihood that such a frame does not have a sudden large change and is suitable for extraction, comparison or for rendering a match (or non-match) determination. Differences between two image frames may be measured in terms of Manhattan distance, Euclidean distance, Mahalanobis distance, or any other measure of similarity or dissimilarity that may be applied or adapted to image frames.

As discussed above, each of the above assessment factors may serve as one or more predetermined criteria for eliminating unsuitable images without performing feature extraction and comparison operations thereon. Alternatively, these factors may serve as the basis for selection of iris segmentation and/or feature extraction operations most suited to the image frame under assessment. For example, a determination that iris shape is non-circular (i.e. does not meet a predefined circularity threshold) may provide basis for iris segmentation and feature extraction operations that do not make a circularity assumption.

The steps of feature extraction and/or comparison may be repeated for every frame that passes the elimination criteria described above. Thus, iris recognition may be terminated when match is found or upon a predetermined timeout, or at any time after a match is found. In a preferred embodiment, feature extraction and/or comparison steps may be repeated 3 or more times a second.

The invention additionally seeks to optimize the iris recognition process in video image capture mode, by implementing multiple pass feature extraction and/or comparison.

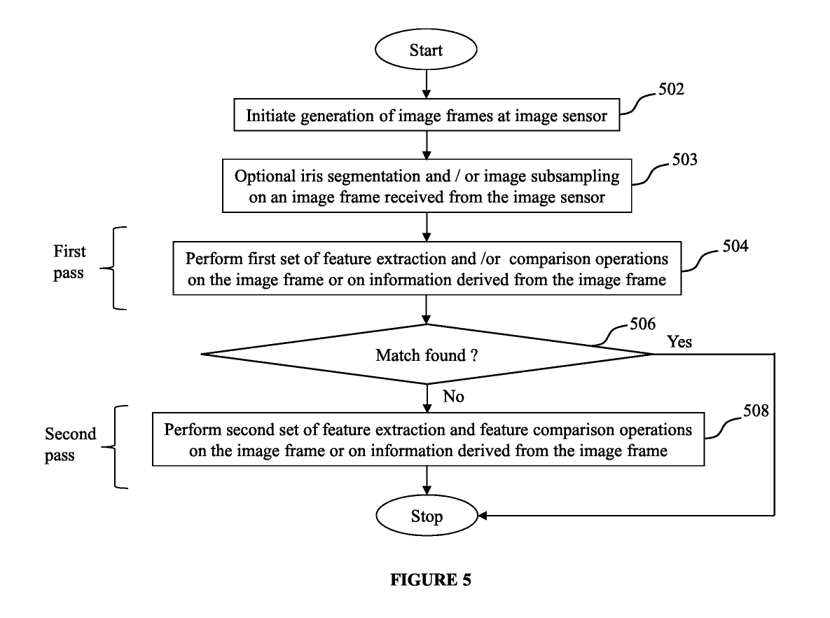

FIG. 5 is a flowchart describing an embodiment of the invention comprising a multiple pass extraction and/or comparison method for iris image recognition. At step 502 the method initiates generation of image frames at an image sensor. The image sensor may be configured to respond to an actuation instruction by capturing images either in single frame image capture mode or in video image capture mode. An image frame generated by the image sensor, which image frame includes an iris image, may be received from the image sensor at a processor.

At step 503, one or both of iris segmentation and image subsampling may be performed on an image frame generated by and received from the image sensor. Equally, the method may omit one or both or may integrate or subsume one or both into one or more of the other image processing steps.

At step 504, a first pass comprising execution of a first set of feature extraction and/or comparison operations, may be carried out either on the received image frame or on image information derived from the received image frame. The first set of feature extraction and/or comparison operations may comprise a first set of feature extraction operations and/or a first set of comparison operations respectively. The first set of feature extraction operations are performed on the received iris image for extracting a first iris feature set of the iris image within the received image frame. The first set of comparison operations may be performed (i) by comparing the first iris feature set with at least one stored iris image template or (ii) by comparing image information corresponding to the received image frame with stored image information corresponding to at least one iris image—which comparison operations are directed at rendering a match (or non-match) determination concerning the iris image within the received image frame.

In an embodiment of the method, the first set of feature extraction and/or comparison operations at step 504 may be performed on unaltered image data corresponding to the image frame as generated at step 502. In a preferred embodiment however, where the received image frame has been subjected to the steps of iris segmentation and/or image subsampling at step 503, feature extraction and/or comparison may be performed based on the output image data arising from said iris segmentation and/or image subsampling.

Step 506 determines whether the first pass results in an output corresponding to a pre-specified outcome (such as for example, if the first pass results in a match), and if so, the method moves to the next step.

If on the other hand, the first pass does not result in an output corresponding to a pre-specified outcome (e.g. if the first pass does not result in a match), a second pass is executed at step 508, comprising applying a second set of feature extraction and/or comparison operations on the received image frame or information derived from the received image frame.

In another embodiment, if the first pass does not result in an output corresponding to a pre-specified outcome, the image frame may be skipped based on some predetermined criteria.

The second set of feature extraction and comparison operations may comprise a second set of feature extraction operations and a second set of comparison operations respectively. The second set of feature extraction operations are performed on the received iris image for extracting a second iris feature set of the iris image within the received image frame. The second set of comparison operations may thereafter be performed by comparing the first iris feature set with at least one stored iris image template retrieved from an iris database—which comparison operations enable rendering of a match (or non-match) decision concerning the iris image within the received image frame.

In one embodiment of the method of FIG. 5, one or both of the first and second set of feature extraction operations may include at least one operation that is not included in the other set of feature extraction operations. In a particular embodiment, the second set of feature extraction operations includes at least one operation not included in the first set of feature extraction operations. Similarly, one or both of the first and second set of comparison operations may include at least one operation that is not included in the other set of comparison operations. In a particular embodiment however, the first and second set of comparison operations may be identical. In yet another particular embodiment, the first and second set of feature extraction operations may be identical.

A match (or non-match) decision is thereafter rendered based on the results of the second pass. In an embodiment of the method, the received image frame may be subjected to the steps of iris segmentation and/or image subsampling at step 503, and feature extraction and/or comparison may be performed on the output image data arising from said iris segmentation and/or image subsampling. In a preferred embodiment of the method however, the second set of feature extraction and/or comparison operations at step 508 are performed on unaltered image frame data corresponding to the image frame as generated at step 502 (i.e. on image frame data that has not been reduced by one or both of iris segmentation and iris subsampling), despite the image frame having been subjected to one or both of optional iris segmentation and image subsampling at step 503.

The first and second set of feature extraction and/or comparison operations, are respectively selected to optimize one or more of time efficiencies and accuracy.

In one embodiment of the method illustrated in FIG. 5, first and second set of feature extraction and/or comparison operations differ from each other in terms of one or more of (i) processing algorithms implemented, (ii) number of instructions for execution (iii) processing resources required (iv) algorithmic complexity, and (v) filters applied to the iris images.

In a preferred embodiment of the method illustrated in FIG. 5, the second set of feature extraction and/or comparison operations are more processor intensive and/or time intensive. As a consequence, executing the first pass is faster and/or requires fewer system resources than executing the second pass. In the event the results of the first pass are sufficient to render a match (or non-match) decision, the method entirely avoids having to run the more complex and/or more computationally intensive second pass feature extraction and/or comparison operations—which significantly improves the time required to render a match (or non-match) decision.

In an embodiment of the method of FIG. 5, where the image frame has been subjected to one or both of iris segmentation and image subsampling at step 503, the first and second set of feature extraction and/or comparison operations may be identical. In this embodiment, the first pass of feature extraction and/or comparison operations is performed on the output image frame data resulting from iris segmentation and/or image subsampling step 503, while the second pass of feature extraction and/or comparison operations is performed on image frame data corresponding to the acquired image frame that has not been reduced by image subsampling.

While not illustrated in FIG. 5, in the event the second pass at step 508 does not render results sufficient to enable a match (or non-match) decision or does not render an output corresponding to a pre-specified outcome, the method may receive another image frame from the image sensor and proceed to repeat steps 503 onwards. Alternatively, in such case the method may simply terminate without receiving another image frame.

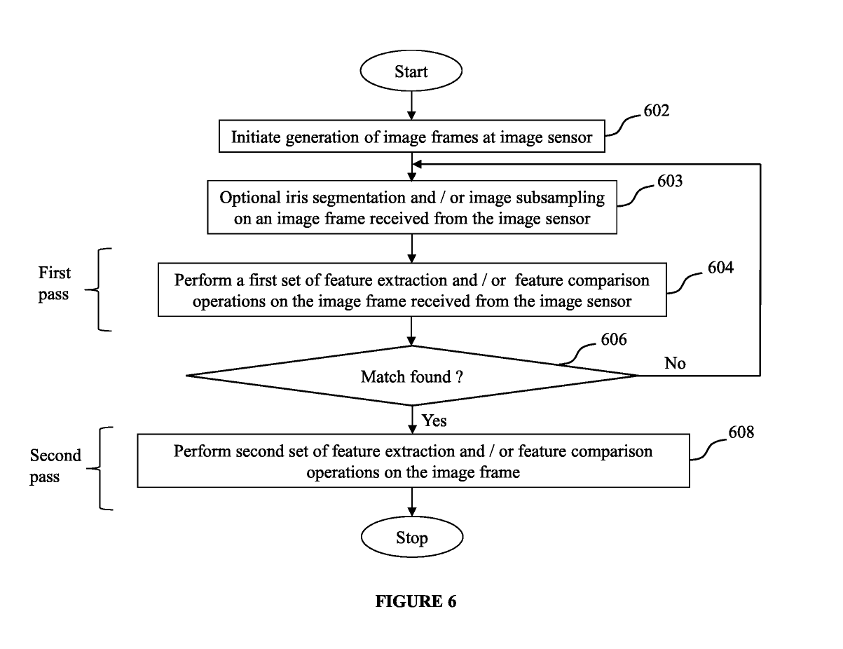

FIG. 6 is a flowchart illustrating another embodiment of the multiple pass extraction and/or comparison method. At step 602 the method initiates generation of image frames at an image sensor. The image sensor may be configured to respond to an actuation instruction by capturing images either in single frame image capture mode or in video image capture mode.

At step 603, one or both of iris segmentation and image subsampling may be performed on an image frame generated by the image sensor and received from the image sensor at a processor. Equally, the method may omit one or both or may integrate or subsume one or both into one or more of the other image processing steps.

At step 604, a first pass comprising execution of a first set of feature extraction and/or comparison operations, is carried out on an image frame received from the image sensor. In an embodiment of the method, the feature extraction and/or comparison operations at step 604 may be performed on unaltered image data corresponding to the image frame as received from the image sensor. In a preferred embodiment however, the received image frame has been subjected to the steps of iris segmentation and/or image subsampling at step 603, and feature extraction and/or comparison may be performed on the output image frame data resulting from said iris segmentation and/or image subsampling.

The first set of feature extraction and/or comparison operations may comprise a first set of feature extraction operations and/or a first set of comparison operations respectively. The first set of feature extraction operations may be performed on the received iris image for extracting a first iris feature set of the iris image within the received image frame. The first set of comparison operations may be performed (i) by comparing the first iris feature set with at least one stored iris image template retrieved from an iris database or (ii) by comparing image information corresponding to the received image frame with stored image information corresponding to at least one iris image—which comparison operations are directed at enabling rendering of a match (or non-match) decision concerning the iris image within the received image frame.

Step 606 determines if a match is found. If a match is found, the image frame under consideration is subjected to a second pass at step 608 comprising execution of a second set of feature extraction and/or comparison operations, and a second match (or non-match) decision is rendered based on the outcome of the second pass. The second set of feature extraction and/or comparison operations may comprise a second set of feature extraction operations and a second set of comparison operations respectively. The second set of feature extraction operations are performed on the received iris image for extracting a second iris feature set of the iris image within the received image frame. The second set of comparison operations may be performed (i) by comparing the second iris feature set with at least one stored iris image template retrieved from an iris database or (ii) by comparing image information corresponding to the received image frame with stored image information corresponding to at least one iris image—which comparison operations are directed at enabling rendering of a match (or non-match) decision concerning the iris image within the received image frame.

If a match is not found at step 606, the method may receive another image frame from the image sensor and proceed to repeat steps 603 to 608. Alternatively, in such case the method may simply terminate without receiving another image frame.

In an embodiment of the method, the acquired image frame has been subjected to the steps of iris segmentation and/or image subsampling at step 603, and the second pass feature extraction and/or comparison at step 608 may be performed on the output image data arising from said iris segmentation and/or image subsampling. In a preferred embodiment of the method however, the second pass feature extraction and/or comparison operations at step 608 are performed on unaltered image data corresponding to the image frame as generated at step 602, despite the image frame having been subjected to one or both of optional iris segmentation and image subsampling at step 603.

In one embodiment of the method of FIG. 6, one or both of the first and second set of feature extraction operations may include at least one operation that is not included in the other set of feature extraction operations. In a particular embodiment, the second set of feature extraction operations includes at least one operation not included in the first set of feature extraction operations. Similarly, one or both of the first and second set of comparison operations may include at least one operation that is not included in the other set of comparison operations. In a particular embodiment however, the first and second set of comparison operations may be identical. In yet another particular embodiment, the first and second set of feature extraction operations may be identical.

The first and second set of feature extraction and/or comparison operations of the method illustrated in FIG. 6 (and particularly the feature extraction operations), may be selected to optimize time efficiencies and accuracy.

In an embodiment of FIG. 6, the first set of feature extraction and/or comparison operations at step 604 is at least (i) less computationally intensive (ii) requiring less processing resources or (iii) having a lower order of algorithmic complexity, than the second set of comparison and/or feature extraction operations at step 608. As a consequence, the first pass of feature extraction and/or comparison operations for identifying candidate image frames, may be executed on a large number of image frames from the set of image frames acquired by the image sensor (and in an embodiment, on all image frames from the set of acquired image frames), without significant time and resource overheads. On the other hand, the more complex/resource intensive second pass of feature extraction and/or comparison operations only requires to be performed on image frames identified as likely candidates for enabling a match (or non-match) decision at the first pass. Taken together, the first and second passes of the method embodiment of FIG. 6 have been found to provide significantly improved response times for a match (or non-match) identity decision, without significant drops in accuracy.

Without limitation, the first and second sets of feature extraction and/or comparison operations of FIG. 6 may differ in terms of either or both of, number and type of filters applied during feature extraction to examine texture of the iris images.

The various two pass methods described above have been found to present significant improvements in processing time and in accuracy of results for iris based image recognition processing.

The present invention additionally presents an improved method for selection of iris image frames for further processing.

Based on the present state of the art, frame rate for image sensors used for iris imaging conventionally range between 5 frames per second and 240 frames per second. At these frame rates, an image sensor acquires a successive image frame at intervals between 1/240^{th} of a second and ⅕^{th} of a second. For example, for an imaging sensor configured to acquire video at 30 frames per second, each successive image frame is acquired at an interval of 1/30^{th} of a second.

It would be understood that motor function or physical reaction time of a subject is typically much slower than the frame rate of an image sensor. Movements or changes such as (i) changing alignment of the subject's head relative to an iris camera, (ii) movement of eyelids or eyelashes, or (iii) any other voluntary and involuntary movements or changes caused by the subject, the operator, or the immediate environment of handheld imaging apparatus, typically involve a time lag of at least 3/10^{th} to 4/10^{th} of a second, and in several cases even more time. It has therefore been observed that not every successive image frame within an iris video clip differs perceptibly from the immediately preceding image frame. More specifically, and depending on multiple factors including motor function of the subject and/or the operator and the immediate environment, perceptible changes between image frames are typically observed in non-successive image frames—which non-successive image frames can be anywhere between every alternate image frame and every 15^{th} successive frame.

The rate at which perceptible changes may be observed in image frames within a video stream, acquires relevance for the reason that extraction and comparison steps that are based on identical or substantially similar image frames would necessarily yield identical or substantially similar results. Accordingly, in the event a particular image frame is unsuitable for extraction and comparison, or for rendering a reliable match (or non-match) decision, selecting a next image frame having perceptible differences compared to the earlier image frame serves to improve the likelihood that the next image frame is suitable for extraction, comparison or rendering a match (or non-match) decision.

For example, in the event a subject's iris is obscured by a blinking eyelid or eyelash at a particular image frame, the likelihood that it remains obscured in the immediately succeeding frame remains high. However, the likelihood of obtaining an image frame of the unobscured eye increases as successive frames are skipped—as each skipped frame improves the probability that the eye's blinking motion has been completed.

Accordingly, instead of performing feature extraction and comparison on each successive frame within a video stream of a subject's iris, the invention skips intermediate frames to improve the probability that the next frame taken up for extraction and comparison differs perceptibly from the earlier frame.

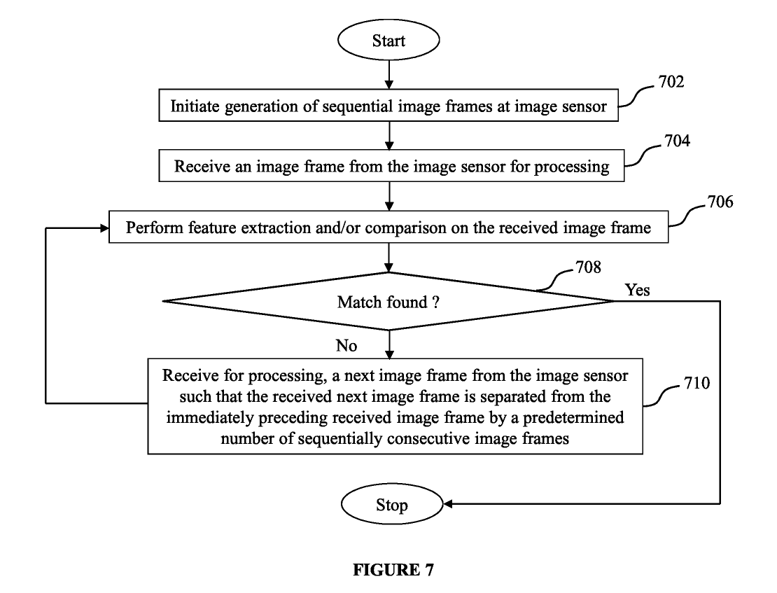

FIG. 7 illustrates an embodiment of this method.

At step 702 an image sensor of the imaging apparatus initializes sequential generation of image frames at an image sensor in video capture mode.

At step 704, an image frame is received from the image sensor, at a processor. The image frame received at step 704 may be the initial image frame within the sequence of image frames generated, or alternatively may be any other image frame therewithin.

Step 706 thereafter implements extraction and/or comparison operations on the received image frame. The extraction and/or comparison operations of step 706 may respectively comprise a set of feature extraction operations and a set of comparison operations. The set of feature extraction operations are performed on the received iris image for extracting an iris feature set of the iris image within the received image frame. The set of comparison operations may be performed (i) by comparing the iris feature set with at least one stored iris image template retrieved from an iris database or (ii) by comparing image information corresponding to the received image frame with stored image information corresponding to at least one iris image—which comparison operations are directed at enabling rendering of a match (or non-match) decision concerning the iris image within the received image frame.

At step 708 the method determines whether a match is found.

If a match is not found at step 708, step 710 receives a next image frame from the generated set of sequential image frames, wherein the next image frame is selected from among the image frames sequentially generated by the image sensor such that the next image frame is separated from the earlier selected image frame in accordance with a predetermined criteria. Feature extraction and/or comparison is performed on the selected next image frame at step 706 and the method continues until a match is found.

The predetermined criteria for selection of a next image frame from among image frames sequentially generated by the image sensor may comprise any criteria that enables selection of a next image frame for processing.

In an embodiment of the invention, the predetermined criteria defines a number of sequentially generated image frames i.e. intermediate frames that are required to separate two image frames that are consecutively taken up for feature extraction and/or comparison. For example, the predetermined criteria may specify the number of intermediate frames required to separate a first image frame and a next image frame that are consecutively taken up for feature extraction and/or comparison.

In an embodiment of the invention, the predetermined criteria may require a uniform distribution of intermediate frames i.e. that every pair of image frames consecutively taken up for feature extraction and/or comparison shall be separated by the same number of image frames sequentially generated by the image sensor. For example, the predetermined criteria may specify that each image frame taken up for feature extraction and/or comparison shall be separated from the immediately preceding image frame taken up for extraction and/or comparison by one image frame—in which case every alternate image frame generated by the image sensor would be taken up for feature extraction and/or comparison. In another embodiment, the predetermined criteria may require a non-uniform distribution of intermediate frames i.e. the number of intermediate image frames separating a first pair of image frames consecutively taken up for feature extraction and/or comparison may be different from the number of intermediate image frames separating a second pair of image frames consecutively taken up for feature extraction and/or comparison. For example, the predetermined criteria may specify that the first and second image frames taken up for feature extraction and/or comparison shall be separated by zero intermediate frames; the second and third image frames taken up for feature extraction and/or comparison shall be separated by two intermediate frames; the third and fourth image frames taken up for feature extraction and/or comparison shall be separated by one intermediate frame; and so on. The non-uniform pattern of distribution of intermediate frames may be varied to optimize efficiency of the iris recognition method.

In another embodiment of the invention, the predetermined criteria defines a time interval separating time of receiving (from the image sensor) a first image frame that is taken up for feature extraction and/or comparison and time of receiving (from the second image sensor) a next image frame that may be taken up for feature extraction and/or comparison. For example, the predetermined criteria may specify that an image frame may be taken up for extraction and/or comparison every 100 milliseconds. The time interval may further specify whether the interval is to be measured based on generation of the image frames at the image sensors (e.g. an image frame generated every 100 milliseconds at the image sensor may be taken up for extraction and/or comparison) or based on receipt of the image frames from the image sensor (e.g. image frames received from the image sensor every 100 milliseconds may be taken up for extraction and/or comparison). As in the case of embodiments discussed above, the time intervals between successive pairs of image frames taken up for extraction and/or comparison may be uniform or non-uniform.

In yet another embodiment, the predetermined criteria may comprise availability status of a resource required for performing image processing or comparison.

The predetermined criteria for selection of two successive image frames for extraction and/or comparison may be a function of one or more of (i) frame speed of the image sensor (ii) human motor function and (iii) time involved in any environment state changes that may be anticipated as a consequence of the iris image acquisition process.

In another embodiment of the invention generally described in connection with FIG. 7, the predetermined criteria for selection of image frames successively taken up for feature extraction and/or comparison is a minimum threshold difference between a first image frame and a next image frame successively taken up for feature extraction and/or comparison. By implementing a minimum threshold for differences between two image frames successively taken up for feature extraction and/or comparison, the invention ensures that each image frame selected for further processing has perceptible differences compared to the earlier processed image frame—which improves the likelihood that such image frame is suitable for extraction, comparison or rendering a match (or non-match) decision. Differences between two image frames may be measured in terms of Manhattan distance, Euclidean distance, Mahalanobis distance, or any other measure of similarity or dissimilarity that may be applied or adapted to image frames. Similarly, minimum threshold difference between a first image frame and a next image frame successively taken up for feature extraction and/or comparison, may be specified in terms of Manhattan distance, Euclidean distance, Mahalanobis distance, or any other measure of similarity or dissimilarity that may be applied or adapted to image frames.

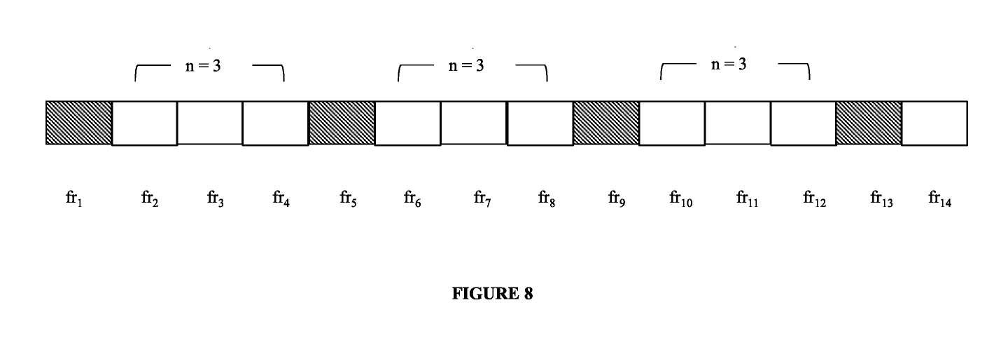

FIG. 8 illustrates an exemplary implementation of the method of FIG. 7, wherein each selected next image frame is separated from the earlier selected image frame by n frames. In the illustration of FIG. 8:
the set of sequential image frames acquired in video mode consist of a total of fourteen consecutive frames (fr₁ to fr₁₄)
the predetermined number of frames (n) separating successively selected image frames is 3 frames (i.e. n=3) and
the image frame first selected for feature extraction and/or comparison is the first image frame in the sequence (fr₁).

Applying the image frame selection criteria of method step 710, image frames fr₅, fr₉ and fr₁₃ would be successively selected for feature extraction and/or comparison under the method described in connection with FIG. 8—with a view to improving the likelihood that each image frame selected for extraction and/or comparison differs perceptibly from the previously selected frame.

In a preferred embodiment of the method described in connection with FIGS. 7 and 8, the predetermined number of frames separating successively selected image frames may be between 0 and 60 frames.

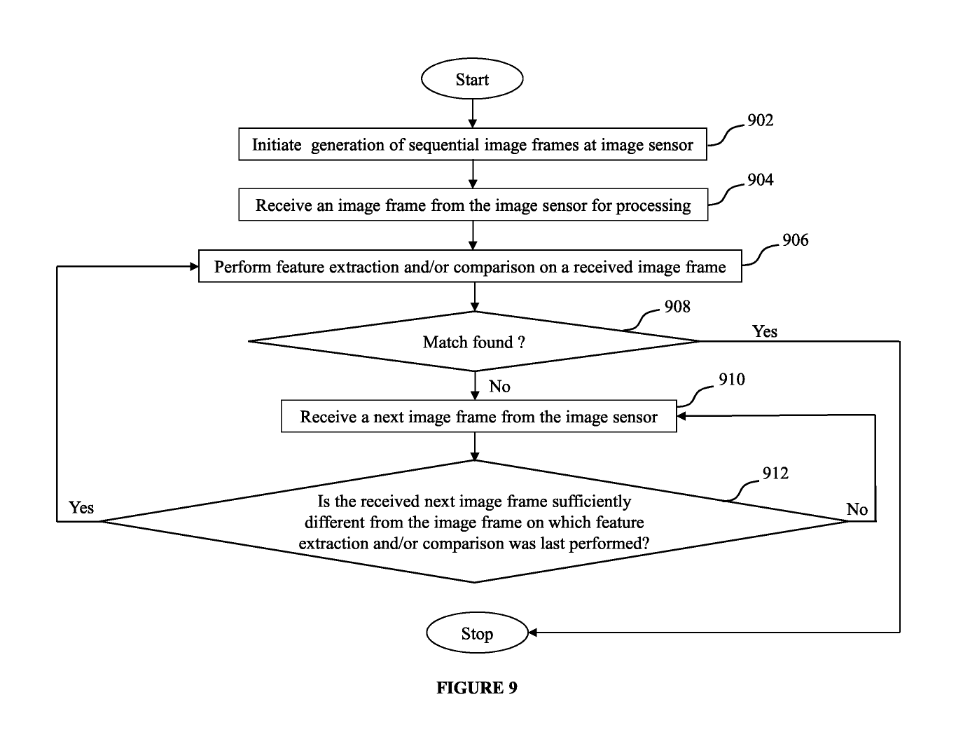

FIG. 9 illustrates another embodiment of the method wherein feature extraction and/or comparison is not performed on each sequential frame successively generated by an image sensor. In this embodiment, an image frame is taken up for feature extraction and/or comparison subsequent to a determination that the image frame is sufficiently different from the image frame on which feature extraction and/or comparison was last performed.

At step 902 the method initiates generation of image frames at an image sensor. The image sensor may be configured to respond to an actuation instruction by capturing images either in single frame image capture mode or in video image capture mode.

At step 904, an image frame is received from the image sensor at a processor for processing. Thereafter at step 906, the processor implements extraction and/or comparison operations on the received image frame.

At step 908 the method determines whether the results of extraction and/or comparison step 906 are sufficient to enable a match (or non-match) decision, and if so, the method may render a match (or non-match) decision and terminate.

If the results of step 906 are insufficient to enable a match (or non-match) decision, step 910 receives a next image frame from the image sensor.

At step 912 the method processes the received next image frame to determine whether said next image frame is sufficiently different from the image frame on comparison and/or extraction was last performed. Differences between two image frames may be measured in terms of Manhattan distance, Euclidean distance, Mahalanobis distance, or any other measure of similarity or dissimilarity that may be applied or adapted to image frames.

In the event the received next image frame is sufficiently different from the image frame on which comparison and/or extraction was last performed, the method reverts to step 906 and feature extraction and comparison operations are performed on the image frame. If the received next image frame is not sufficiently different from the image frame on which feature extraction and/or comparison was last performed, the method reverts to step 910 wherein a next image frame is received from the image sensor.

The method may continue until a match (or non-match) decision is reached, or until no additional frames remain to be received from the image sensor, or until a feature extraction and/or comparison have been performed on a predetermined number of frames, or upto expiry of a predetermined interval of time or other termination event.

In addition to the methods described above, the present invention achieves efficiencies in image quality assessment and image processing, using specifically configured imaging apparatuses.

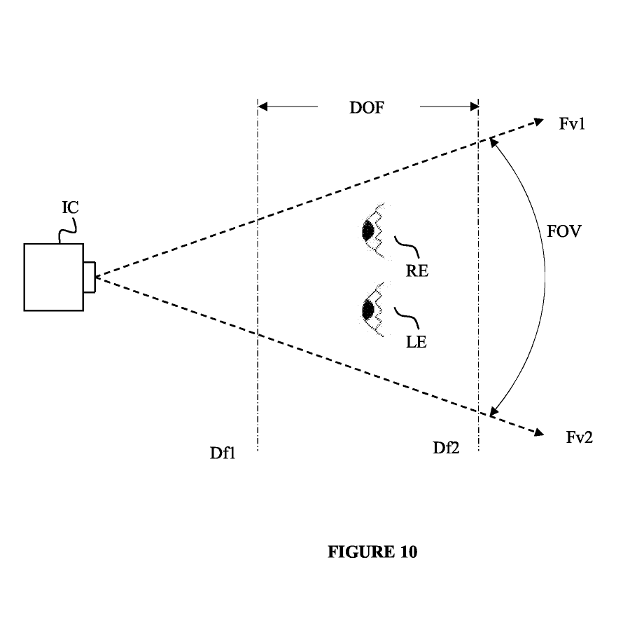

FIG. 10 illustrates a top view of an iris imaging apparatus capable of implementing one or more embodiments of the present invention. The iris imaging apparatus IC has a finite and fixed field of view FOV (i.e. the volume of inspection capable of being captured on the camera's image sensor). In FIG. 10, field of view FOV is the region defined by dashed lines Fv1 and Fv2. Iris imaging apparatus IC additionally has a depth of field DOF—wherein depth of field DOF defines the region within which a subject's iris would appear acceptably sharp and in sufficient detail for the purposes of iris image capture. In FIG. 10, depth of field DOF is the region between dashed lines Df1 and Df2, along the z axis.

Field of view FOV of iris imaging apparatus IC is configured such that when a subject's face is positioned within depth of field DOF, both of the subject's eyes LE and RE can be simultaneously accommodated within field of view FOV. Stated differently, field of view FOV of iris imaging apparatus IC is sufficiently wide to enable a subject's left eye LE and right eye RE to be simultaneously imaged by the iris camera when positioned within depth of field DOF. Accordingly, if a subject's face is positioned such that both left and right eyes of the subject are positioned within the intersection of the depth of field DOF and field of view FOV of the iris imaging apparatus, a single image frame acquired by the iris imaging apparatus would include images of both left and right eyes. Iris imaging apparatus IC includes an image sensor 204 and an optical assembly 206 for iris image acquisition and further image processing.

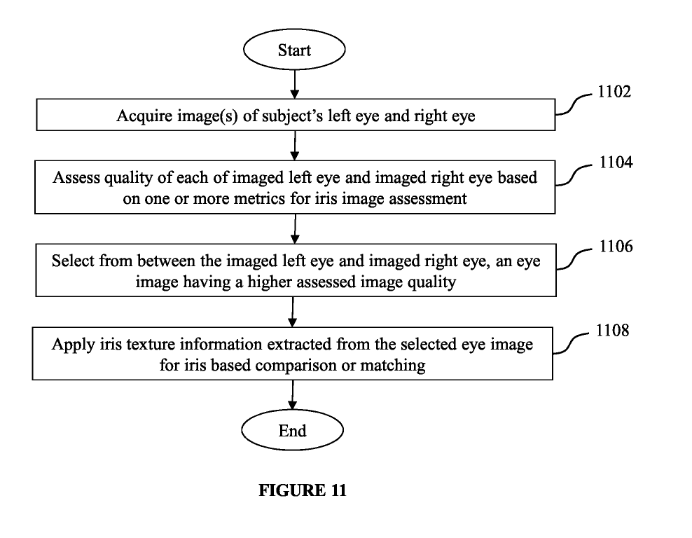

FIG. 11 illustrates specific embodiment of the present invention. At step 1102, an image frame(s) imaging both of a subject's left eye and right eye is acquired. Since the iris imaging apparatus of the present invention is configured in accordance with the arrangement illustrated in FIG. 10, appropriate positioning of a subject's face within the intersection of the depth of field and field of view, would result in capture of the subject's left eye and right eye within a single image frame.

Step 1104 comprises assessing quality of each of the imaged left eye and imaged right eye based on one or more metrics for iris image quality assessment. In an embodiment, metrics for iris image quality assessment may include any metric capable of evaluating quality or quantity of extractable iris texture information corresponding to an imaged eye.

At step 1106, from among the image of the left eye and the image of the right eye, the method selects the imaged eye having a higher image quality assessment. Iris texture information extracted from the selected imaged eye may thereafter be applied at step 1108 for the purposes of comparison or matching against previously acquired or enrolled iris images.

By relying on iris texture information extracted from the imaged eye image having a higher image quality, the invention reduces likelihood of false match or false non-match results even within a single image frame. Additionally, since an acquired image frame includes images of both eyes of a subject, there is an increased likelihood of at least one of the subject's eyes within an acquired image frame having sufficient extractable iris texture information for comparison purposes—thereby presenting the possibility of reducing the number of image frames which need to be acquired and processed.

The method additionally offers opportunities for simultaneously processing or sequentially processing or parallel processing of image information. In an exemplary embodiment, regions of the acquired image frame that respectively accommodate an imaged left eye and right eye may be processed within separate processing threads—thereby enabling parallel execution of at least the image quality step (step 1104) in respect of each of the acquired eye images. In another exemplary embodiment, a single processing thread first processes one of the acquired left and right eye images and thereafter processes the other of the two left and right eye images.

While step 1102 of the above description of FIG. 11 discloses acquiring a single image frame which includes images of the subject's left and right eye, another embodiment of the method may at step 1102 involve acquisition of two separate image frames, respectively imaging a subject's left eye and a subject's right eye. Steps 1104 to step 1108 of FIG. 11 would thereafter proceed in the same manner as described above.

In an embodiment of the invention, the metrics for iris image quality assessment described in connection with step 1104 above, may be defined in terms of one or more of the following attributes of an image frame under assessment: (i) grayscale spread (ii) iris size (iii) dilation (iv) usable iris area (v) iris-sclera contrast (vi) iris-pupil contrast (vii) iris shape (viii) pupil shape (ix) image margins (x) image sharpness (xi) motion blur (xii) signal to noise ratio (xiii) gaze angle and (xiv) scalar score. Each of the above factors for assessment has already been described above at step 405.

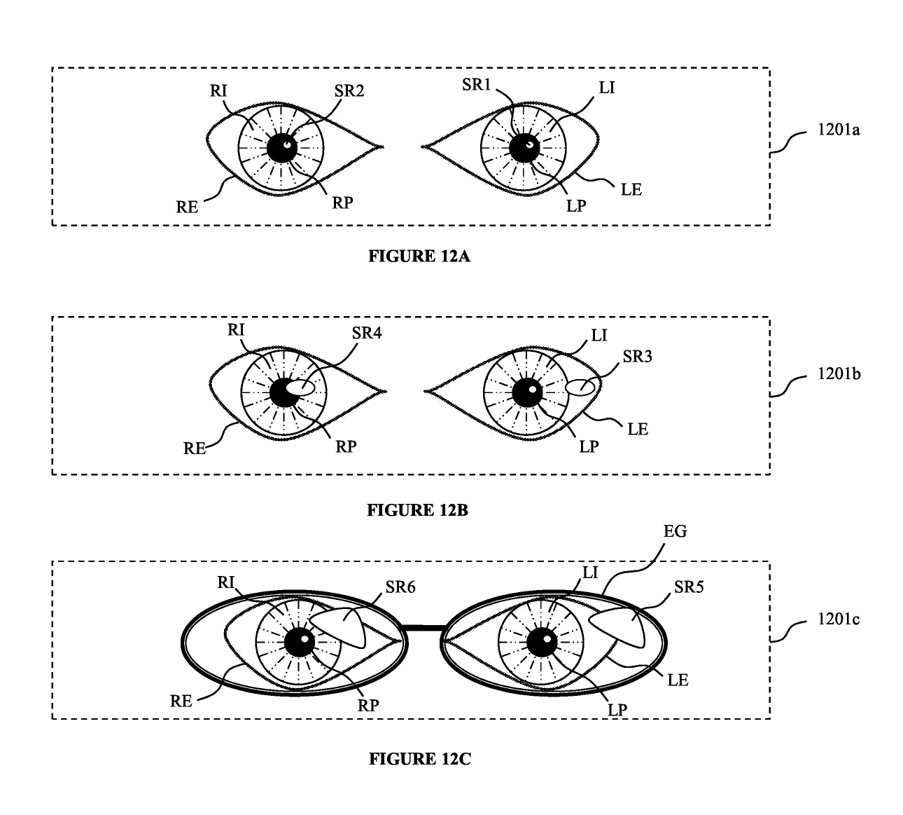

Each of FIGS. 12A, 12B and 12C illustrate an image frame (1201a, 1201b and 1201c) which includes an image of a subject's left and right eyes.

In FIG. 12A, subject's left eye LE comprises left iris LI and left pupil LP, while right eye RE comprises right iris RI and right pupil RP. It will be noted that left pupil LP and right pupil RP respectively have specular reflections SR1 and SR2 obscuring part of the pupil. However, since specular reflections SR1 and SR2 do not obscure or otherwise interfere with the usable iris area of either left iris LI or right iris RI, such reflections would not affect iris image quality for the purpose of iris recognition.

In FIG. 12B on the other hand, specular reflection SR3 is positioned at the perimeter of left iris LI within left eye LE, while specular reflection SR4 partially obscures part of right iris RI and part of right pupil RP. Therefore, specular reflection SR4 significantly reduces usable iris area of right iris RI, whereas specular reflection SR3 has little or no impact on the usable iris area of left iris LI. Accordingly, in a method according to FIG. 11, the imaged left eye LE would be selected over the imaged right eye RI from image frame 1201b, for extraction of iris texture information for iris based comparison or matching.

FIG. 12C illustrates the effect of specular reflections when a pair of eyeglasses EG comprising Lens 1 and Lens 2 are interposed between the iris imaging apparatus and a subject's eyes. Specular reflection SR5 reflects off a surface of Lens 1 (which is interposed between the iris imaging apparatus and a subject's left eye LE) such that it does not interfere or obscure any part of left iris LI within left eye LE. Specular reflection SR6 on the other hand reflects off Lens 2 (which is interposed between the iris imaging apparatus and the subject's right eye RE) and partially obscures part of right iris RI. Specular reflection SR6 accordingly significantly reduces usable iris area of right iris RI, whereas specular reflection SR5 has no impact on the usable iris area of left iris LI. Accordingly, in a method according to FIG. 11, the imaged left eye LE would be selected over the imaged right eye RI from image frame 1201c, for extraction of iris texture information for iris based comparison or matching.

FIGS. 12A, 12B and 12C illustrate results of the method of FIG. 11, where the image quality assessment metric comprises assessing occlusion of usable iris area as a consequence of specular reflections. It would however be understood that the invention may be used to assess any other type of occlusion of usable iris area (including occlusion by eyelashes, eyelids, eyebrows, or any external object) as well as any other image quality metric discussed above.

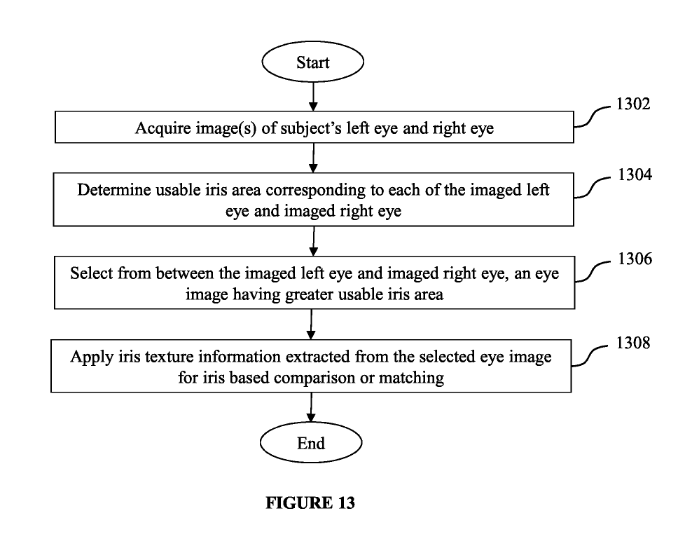

FIG. 13 illustrates a preferred embodiment of the present invention more generally described in FIG. 11 above. At step 1302, an image frame imaging both of a subject's left eye and right eye is acquired. As discussed above, appropriate positioning of a subject's face within the intersection of the depth of field and field of view of the imaging apparatus of the type illustrated in FIG. 10 would result in capture of the subject's left eye and right eye within a single image frame.

Step 1304 comprises determining usable iris area corresponding to each of the imaged left eye and the imaged right eye. In an embodiment of the invention usable iris area may be measured as the percentage of iris that is not occluded by eyelash(es), eyelid(s), eyebrow(s), specular reflections off the eyes or contact lenses or eyeglasses, specular reflections caused by an illuminator of the imaging apparatus, or by ambient light, or any other light source, or any external object. At step 1306, the method selects (from among the image of the left eye and the image of the right eye), the imaged eye having higher usable iris area. Iris texture information extracted from the selected imaged eye may thereafter be applied at step 1308 for the purposes of comparison or matching against previously acquired or enrolled iris images.

While step 1302 of the above description discloses acquiring a single image frame which includes images of the subject's left and right eye, another embodiment of the method may at step 1302 involve acquisition of two separate image frames, respectively imaging a subject's left eye and a subject's right eye. Steps 1304 to step 1308 of FIG. 13 would thereafter proceed in the same manner as described above.

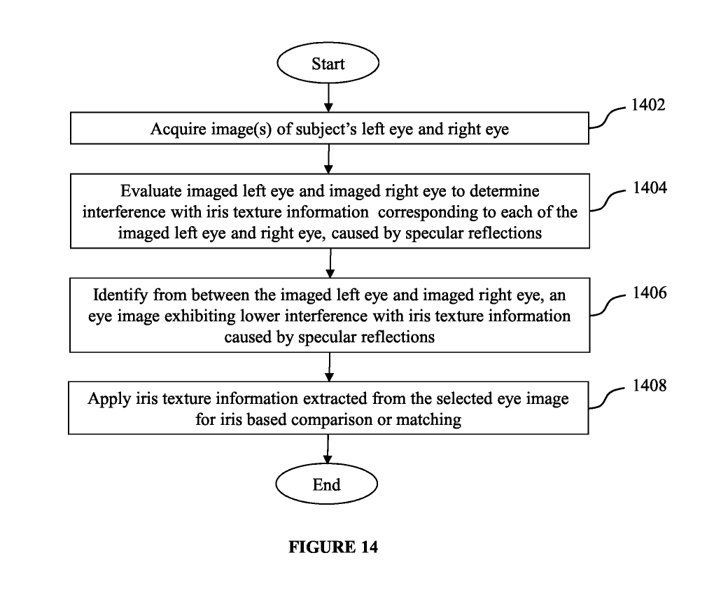

FIG. 14 illustrates another specific embodiment of the present invention. At step 1402, an image frame imaging both of a subject's left eye and right eye is acquired. As discussed previously, appropriate positioning of a subject's face within the intersection of the depth of field and field of view of the imaging apparatus as illustrated in FIG. 10 would result in capture of the subject's left eye and right eye within a single image frame.

Step 1404 comprises determining interference with iris texture information corresponding to each of the imaged left eye and right eye, caused by specular reflections off one or more of an eyeball surface, contact lenses disposed on an eyeball surface, or eyeglass surface(s) disposed between a subject's eye and the iris imaging apparatus. It would be understood that interference with iris texture information may be caused by specular reflections which obscure part or whole of a subject's iris in the acquired iris image. Interference caused in connection with iris texture information by specular reflections may be evaluated based on any one of a number of criteria including, usable iris area in the acquired iris images, shape, size or number of specular reflections occluding a subject's iris, and relative position of specular reflections with respect to an iris.

At step 1406, the method selects (from among the imaged left eye and the imaged right eye), the imaged eye exhibiting lower interference (caused by specular reflections) with iris texture information. Iris texture information extracted from the selected eye image may thereafter be applied at step 1408 for the purposes of comparison or matching against previously acquired or enrolled iris images.

Again while step 1402 of the above description discloses acquiring a single image frame which includes images of the subject's left and right eye, another embodiment of the method may at step 1402 acquire two separate image frames, respectively imaging a subject's left eye and a subject's right eye. Steps 1404 to step 1408 of FIG. 14 would thereafter proceed in the same manner as described above.

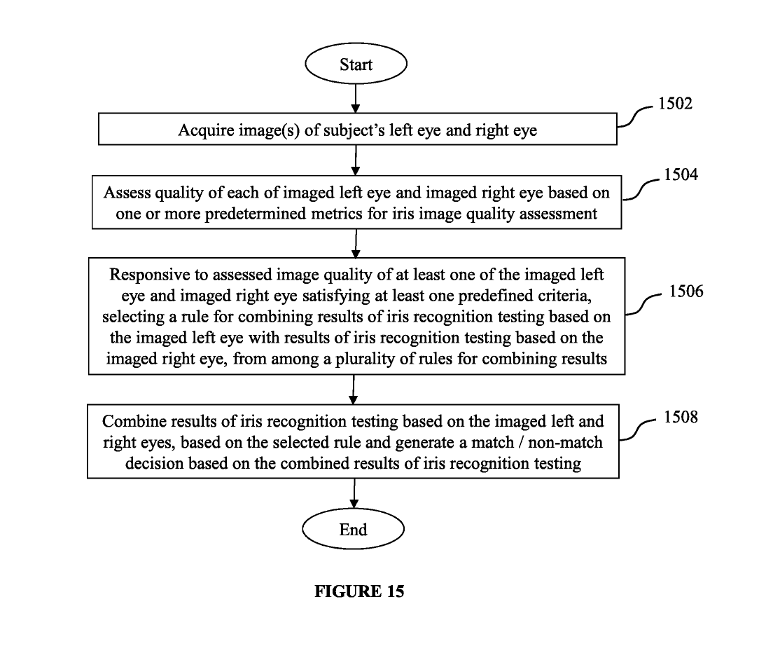

FIG. 15 illustrates an embodiment of the present invention wherein assessment of image quality of one or both of a subject's eyes is determinant of a decision for combining results of iris recognition testing of each eye.

It is known that results of two or more biometric tests may be combined for an enhanced test. Testing of a subject's identity based on iris recognition testing of both of a subject's eyes is known to result in enhanced performance and reduction in error rates. There are however time and computational efficiency costs associated with extracting iris texture information from both of a subject's eyes and comparing extracted iris texture information corresponding to both eyes against previously acquired iris images. The embodiment of the invention illustrated in FIG. 15 balances the competing interests of accuracy against time and computational efficiency related costs.

At step 1502, a subject's left eye and right eye are imaged. As discussed above, in an embodiment, appropriate positioning of a subject's face within the intersection of the depth of field and field of view of an imaging apparatus of the type illustrated in FIG. 10 would result in capture of the subject's left eye and right eye within a single image frame.

Step 1504 comprises assessing quality of each of the imaged left eye and imaged right eye based on any one or more metrics for iris image quality assessment, which may include any one of the image quality metrics discussed previously.

Responsive to the assessed image quality of at least one of the imaged left eye and the imaged right eye matching at least one predefined criteria, step 1506 selects a corresponding rule for combining results of iris recognition testing based on the imaged left eye with results or iris recognition testing based on the imaged right eye. The rule for combining results may be selected from among a plurality of different rules, each of which specify a unique method of combining results of iris recognition testing based on the imaged left eye with results of iris recognition testing based on the imaged right eye. Step 1508 combines results of iris recognition testing respectively based on the imaged left and right eyes and generates a match/non-match decision based on the combined results of iris recognition testing.

Each rule for combining results of iris recognition testing of a subject's left and right eye, may describe a method of combining results of two independent biometric tests. Exemplary rules for combining results may include:
a disjunctive acceptance test—i.e. wherein a match decision is arrived at responsive to a match determination in respect of either of the subject's eyes.
a conjunctive acceptance test—i.e. wherein a match decision is arrived at responsive to a match determination in respect of both of the subject's eyes.

A decision regarding selection of a specific rule from among the plurality of rules for combining results may be arrived at in response to a determination that assessed image quality of one or both of the imaged eyes meets a predetermined criteria. Exemplary predetermined criteria include:
Either one of the imaged eyes failing to satisfy one or more minimum thresholds for iris image quality.
Both of the imaged eyes failing to satisfy one or more minimum thresholds for iris image quality.
Assessed image quality parameters for one or both of the imaged eyes satisfying one or more prescribed parameter values, or falling within a prescribed range of parameter values.

In an embodiment of the invention, each predefined criteria may be mapped to one or more specific rules for combining results of iris recognition testing respectively based on the imaged left and right eyes—such that said one or more specific rules for combining results would be invoked responsive to a determination that the corresponding predefined criteria has been met. As discussed in further detail below, method steps from FIG. 11, 13, 14 or 15 may be combined in a variety of ways with method steps more generally described in connection with FIGS. 4 to 9. Some exemplary embodiments consisting of such combinations of method steps are described below.

In one embodiment, method steps from the method of FIG. 4, may be combined with method steps from any of FIG. 11, 13, 14 or 15. The combined method commences according to the method of FIG. 4 by receiving an image frame (step 402) and optionally performing iris segmentation at step 404. At step 405 (which comprises determining whether the received image frame(s) or derivative subsampled image frame(s) or image information derived from the received image frame(s) meets a predetermined criteria) the method determines whether at least one iris is positioned within the field of view FOV of the iris imaging apparatus.

Responsive to step 405 determination that the field of view FOV does not have at least one iris positioned therewithin, the method does not proceed to the next step, and instead reverts to step 402 to receive another image frame from the image sensor. If field of view FOV is found to have a single iris positioned therewithin, the method may instead proceed to step 406 for feature extraction and thereafter sequentially through remaining steps 408 to 409 illustrated in FIG. 4.

Alternatively however, responsive to step 405 determination that the field of view FOV includes two irises positioned therewithin (i.e. irises corresponding to an imaged left eye and an imaged right eye), the method may instead proceed to steps 1104 to 1108 of FIG. 11—which steps comprise (i) assessing quality of each of the imaged left iris and imaged right iris, based on one or more metrics for iris image assessment (step 1104), (ii) selecting from between the imaged left iris and imaged right iris, an imaged iris having a higher assessed image quality (step 1106) and (iii) applying iris texture information extracted from the selected imaged eye for iris based comparison or matching (step 1108).

In another embodiment, responsive to a step 405 determination that the field of view FOV has two irises positioned therewithin (i.e. irises corresponding to an imaged left eye and an imaged right eye), the method may proceed to steps 1304 to 1308 of FIG. 13, respectively comprising (i) determining usable iris area corresponding to each of the imaged left iris and imaged right iris (step 1304), (ii) selecting from between the imaged left iris and imaged right iris, an imaged iris having the greater usable iris area (step 1306) and (iii) applying iris texture information extracted from the selected imaged iris for iris based comparison or matching (step 1308).

In an alternate embodiment, responsive to a step 405 determination that the field of view FOV has two irises positioned therewithin (i.e. irises corresponding to an imaged left eye and an imaged right eye), the method may proceed to steps 1404 to 1408 of FIG. 14, respectively comprising (i) evaluating the imaged left iris and imaged right iris to determine interference with iris texture information corresponding to each of the imaged left eye and right eye, caused by specular reflections (step 1404), (ii) selecting from between the imaged left iris and imaged right iris, an imaged iris exhibiting lower interference with iris texture information caused by specular reflections (step 1406) and (iii) applying iris texture information extracted from the selected imaged iris for iris based comparison or matching (step 1408).

In yet another embodiment, responsive to a step 405 determination that the field of view FOV has two irises positioned therewithin (i.e. irises corresponding to an imaged left eye and an imaged right eye), the method may proceed to steps 1504 to 1508 of FIG. 15, respectively comprising (i) assessing quality of each of the imaged left iris and imaged right iris based on one or more predetermined metrics for iris image quality assessment (step 1504), (ii) responsive to assessed image quality of at least one of the imaged left iris and imaged right iris satisfying at least one predefined criteria, selecting a rule for combining results of iris recognition testing based on the imaged left iris with results of iris recognition testing based on the imaged right iris, which selection is from among a plurality of available rules for combining results (step 1506) and (iii) combining results of iris recognition testing based on the imaged left and right eyes, based on the selected rule and generating a match/non-match decision based on the combined results of iris recognition testing (step 1508).

In another set of invention embodiments, method steps of FIG. 11, 13 or 14 may be combined with methods more generally described in connection with FIG. 5 or 6.

A method embodiment combining method steps of FIG. 11 with method steps of FIG. 5, comprises (i) acquiring image(s) of a subject's left iris and right iris—which are simultaneously positioned within field of view FOV of the iris imaging apparatus (step 1102), (ii) assessing quality of each of the imaged left iris and imaged right iris based on one or more metrics for iris image assessment (step 1104), and (iii) selecting from between the imaged left iris and imaged right iris, an imaged iris having a higher assessed image quality (step 1106). Thereafter the invention proceeds to sequentially execute steps 504 to 508 of FIG. 5, comprising (i) performing a first set of feature extraction and/or comparison operations on the selected iris image or on information derived from the selected iris image (step 504) and (ii) responsive to the first set of feature extraction and/or comparison operations not resulting in a match, performing a second step of feature extraction and feature comparison operations on the selected iris image or on information derived from the selected iris image (step 508).

Another embodiment which combines method steps of FIG. 11 with method steps of FIG. 6, comprises (i) acquiring image(s) of a subject's left iris and right iris—which are simultaneously positioned within field of view FOV of the iris imaging apparatus (step 1102), (ii) assessing quality of each of the imaged left iris and imaged right iris based on one or more metrics for iris image assessment (step 1104), and (iii) selecting from between the imaged left iris and imaged right iris, an imaged iris having a higher assessed image quality (step 1106). Thereafter the invention proceeds to sequentially execute steps 604 to 608 of FIG. 6, comprising (i) performing a first set of feature extraction and/or comparison operations on the selected iris image or on information derived from the selected iris image (step 604) and (ii) responsive to the first set of feature extraction and/or comparison operations resulting in a match, performing a second step of feature extraction and feature comparison operations on the selected iris image or on information derived from the selected iris image (step 608).

An embodiment combining method steps of FIG. 13 with method steps of FIG. 5, comprises (i) acquiring image(s) of a subject's left iris and right iris—which are simultaneously positioned within field of view FOV of the iris imaging apparatus (step 1302), (ii) determining usable iris area corresponding to each of the imaged left iris and imaged right iris (step 1304), and (iii) selecting from between the imaged left iris and imaged right iris, an imaged iris having greater usable iris area (step 1306). Thereafter the invention proceeds to sequentially execute steps 504 to 508 of FIG. 5, comprising (i) performing a first set of feature extraction and/or comparison operations on the selected iris image or on information derived from the selected iris image (step 504) and (ii) responsive to the first set of feature extraction and/or comparison operations not resulting in a match, performing a second step of feature extraction and feature comparison operations on the selected iris image or on information derived from the selected iris image (step 508).

Another embodiment combining method steps of FIG. 13 with method steps of FIG. 6, comprises (i) acquiring image(s) of a subject's left iris and right iris—which are simultaneously positioned within field of view FOV of the iris imaging apparatus (step 1302), (ii) determining usable iris area corresponding to each of the imaged left iris and imaged right iris (step 1304), and (iii) selecting from between the imaged left iris and imaged right iris, an imaged iris having greater usable iris area (step 1306). Thereafter the invention proceeds to sequentially execute steps 604 to 608 of FIG. 6, comprising (i) performing a first set of feature extraction and/or comparison operations on the selected iris image or on information derived from the selected iris image (step 604) and (ii) responsive to the first set of feature extraction and/or comparison operations resulting in a match, performing a second step of feature extraction and feature comparison operations on the selected iris image or on information derived from the selected iris image (step 608).

An embodiment combining method steps of FIG. 14 with method steps of FIG. 5, comprises (i) acquiring image(s) of a subject's left iris and right iris—which are simultaneously positioned within field of view FOV of the iris imaging apparatus (step 1402), (ii) evaluating the imaged left iris and imaged right iris to determine interference with iris texture information corresponding to each of the imaged left iris and right iris, caused by specular reflections (step 1404), and (iii) identifying from between the imaged left iris and imaged right iris, an imaged iris exhibiting lower interference with iris texture interference with iris texture information caused by specular reflections (step 1406). Thereafter the invention proceeds to sequentially execute steps 504 to 508 of FIG. 5, comprising (i) performing a first set of feature extraction and/or comparison operations on the selected iris image or on information derived from the selected iris image (step 504) and (ii) responsive to the first set of feature extraction and/or comparison operations not resulting in a match, performing a second step of feature extraction and feature comparison operations on the selected iris image or on information derived from the selected iris image (step 508).

Another embodiment combining method steps of FIG. 14 with method steps of FIG. 6, comprises (i) acquiring image(s) of a subject's left iris and right iris—which are simultaneously positioned within field of view FOV of the iris imaging apparatus (step 1402), (ii) evaluating the imaged left iris and imaged right iris to determine interference with iris texture information corresponding to each of the imaged left iris and right iris, caused by specular reflections (step 1404), and (iii) identifying from between the imaged left iris and imaged right iris, an imaged iris exhibiting lower interference with iris texture interference with iris texture information caused by specular reflections (step 1406). Thereafter the invention proceeds to sequentially execute steps 604 to 608 of FIG. 6, comprising (i) performing a first set of feature extraction and/or comparison operations on the selected iris image or on information derived from the selected iris image (step 604) and (ii) responsive to the first set of feature extraction and/or comparison operations resulting in a match, performing a second step of feature extraction and feature comparison operations on the selected iris image or on information derived from the selected iris image (step 608).

In a further set of method embodiments of the invention, the methods illustrated in FIG. 7 or 9 may be combined with any of the methods described in connection with FIG. 11, 13, 14 or 15.

In an embodiment of the invention more generally discussed in connection with the method of FIG. 7, step 702 comprises initiating generation of sequential image frames at an image sensor, followed at step 704 by receiving (from the image sensor for processing), an image frame or image information corresponding to a field of view FOV of the iris imaging apparatus.

Responsive to a determination that the field of view FOV of the imaging apparatus has two irises positioned therewithin (i.e. irises corresponding to an imaged left eye and an imaged right eye), the method proceeds through steps 1104 upto 1108, comprising (i) assessing quality of each of the imaged left iris and imaged right iris based on one or more metrics for iris image assessment (step 1104), (ii) selecting from between the imaged left iris and imaged right iris, an imaged iris having a higher assessed image quality (step 1106) and (iii) applying iris texture information extracted from the selected imaged eye for iris based comparison or matching (step 1108). Thereafter, the method reverts to step 708 to check if a match is found, and if no match is found, receives for processing (at step 710) a selected next image frame from the image sensor such that selection of the next image frame is based on one or more of (i) availability of a resource to perform image processing or comparison, or (ii) elapse of a specified time interval since occurrence of a defined event corresponding to a previously selected image frame, or (iii) the received next image frame is separated from the immediately preceding received image frame by a predetermined number of sequentially consecutive image frames.

In an alternative embodiment, responsive to a determination that the field of view FOV has two irises positioned therewithin (i.e. irises corresponding to an imaged left eye and an imaged right eye), the method may proceed through steps 1304 to 1308 of FIG. 13, respectively comprising (i) determining usable iris area corresponding to each of the imaged left iris and imaged right iris (step 1304), (ii) selecting from between the imaged left iris and imaged right iris, an imaged iris having the greater usable iris area (step 1306) and (iii) applying iris texture information extracted from the selected imaged iris for iris based comparison or matching (step 1308). Thereafter, the method may revert to step 708 to check if a match is found, and if no match is found, receives for processing (at step 710) a selected next image frame from the image sensor such that selection of the next image frame is based on one or more of (i) availability of a resource to perform image processing or comparison, or (ii) elapse of a specified time interval since occurrence of a defined event corresponding to a previously selected image frame, or (iii) the received next image frame is separated from the immediately preceding received image frame by a predetermined number of sequentially consecutive image frames.

In yet another embodiment, responsive to a determination that the field of view FOV has two irises positioned therewithin (i.e. irises corresponding to an imaged left eye and an imaged right eye), the method may proceed to steps 1404 to 1408 of FIG. 14, respectively comprising (i) evaluating the imaged left iris and imaged right iris to determine interference with iris texture information corresponding to each of the imaged left eye and right eye, caused by specular reflections (step 1404), (ii) selecting from between the imaged left iris and imaged right iris, an imaged iris exhibiting lower interference with iris texture information caused by specular reflections (step 1406) and (iii) applying iris texture information extracted from the selected imaged iris for iris based comparison or matching (step 1408). Thereafter, the method may revert to step 708 to check if a match is found, and if no match is found, receives for processing (at step 710) a selected next image frame from the image sensor such that selection of the next image frame is based on one or more of (i) availability of a resource to perform image processing or comparison, or (ii) elapse of a specified time interval since occurrence of a defined event corresponding to a previously selected image frame, or (iii) the received next image frame is separated from the immediately preceding received image frame by a predetermined number of sequentially consecutive image frames.

In a further embodiment, responsive to a determination that the field of view FOV has two irises positioned therewithin (i.e. irises corresponding to an imaged left eye and an imaged right eye), the method may proceed to steps 1504 to 1508 of FIG. 15, respectively comprising (i) assessing quality of each of the imaged left iris and imaged right iris based on one or more predetermined metrics for iris image quality assessment (step 1504), (ii) responsive to assessed image quality of at least one of the imaged left iris and imaged right iris satisfying at least one predefined criteria, selecting a rule for combining results of iris recognition testing based on the imaged left iris with results of iris recognition testing based on the imaged right iris, which selection is from among a plurality of available rules for combining results (step 1506) and (iii) combining results of iris recognition testing based on the imaged left and right eyes, based on the selected rule and generating a match/non-match decision based on the combined results of iris recognition testing (step 1508). Thereafter, the method may revert to step 708 to check if a match is found, and if no match is found, receives for processing (at step 710) a selected next image frame from the image sensor such that selection of the next image frame is based on one or more of (i) availability of a resource to perform image processing or comparison, or (ii) elapse of a specified time interval since occurrence of a defined event corresponding to a previously selected image frame, or (iii) the received next image frame is separated from the immediately preceding received image frame by a predetermined number of sequentially consecutive image frames.

In an embodiment of the invention more generally discussed in connection with the method of FIG. 9, step 902 comprises initiating generation of sequential image frames at an image sensor, followed at step 904 by receiving (from the image sensor for processing), an image frame or image information corresponding to a field of view FOV of the iris imaging apparatus.

Responsive to a determination that the field of view FOV has two irises positioned therewithin (i.e. irises corresponding to an imaged left eye and an imaged right eye), the method proceeds through steps 1104 upto 1108, comprising (i) assessing quality of each of the imaged left iris and imaged right iris based on one or more metrics for iris image assessment (step 1104), (ii) selecting from between the imaged left iris and imaged right iris, an imaged iris having a higher assessed image quality (step 1106) and (iii) applying iris texture information extracted from the selected imaged eye for iris based comparison or matching (step 1108). Thereafter, the method reverts to (i) step 908 to check if a match is found, (ii) responsive to no match being found, receives for processing (at step 910) a next image frame from the image sensor, and (iii) subjects the received next image frame to further processing responsive to determining that the received next image frame is sufficiently different from the image frame on which feature extraction and/or comparison was last performed (at step 912).

In an alternative embodiment, responsive to a determination that the field of view FOV has two irises positioned therewithin (i.e. irises corresponding to an imaged left eye and an imaged right eye), the method may proceed to steps 1304 to 1308 of FIG. 13, respectively comprising (i) determining usable iris area corresponding to each of the imaged left iris and imaged right iris (step 1304), (ii) selecting from between the imaged left iris and imaged right iris, an imaged iris having the greater usable iris area (step 1306) and (iii) applying iris texture information extracted from the selected imaged iris for iris based comparison or matching (step 1308). Thereafter, the method reverts to (i) step 908 to check if a match is found, (ii) responsive to no match being found, receives for processing (at step 910) a next image frame from the image sensor, and (iii) subjects the received next image frame to further processing responsive to determining that the received next image frame is sufficiently different from the image frame on which feature extraction and/or comparison was last performed (at step 912).

In yet another embodiment, responsive to a determination that the field of view FOV has two irises positioned therewithin (i.e. irises corresponding to an imaged left eye and an imaged right eye), the method may proceed to steps 1404 to 1408 of FIG. 14, respectively comprising (i) evaluating the imaged left iris and imaged right iris to determine interference with iris texture information corresponding to each of the imaged left eye and right eye, caused by specular reflections (step 1404), (ii) selecting from between the imaged left iris and imaged right iris, an imaged iris exhibiting lower interference with iris texture information caused by specular reflections (step 1406) and (iii) applying iris texture information extracted from the selected imaged iris for iris based comparison or matching (step 1408). Thereafter, the method reverts to (i) step 908 to check if a match is found, (ii) responsive to no match being found, receives for processing (at step 910) a next image frame from the image sensor, and (iii) subjects the received next image frame to further processing responsive to determining that the received next image frame is sufficiently different from the image frame on which feature extraction and/or comparison was last performed (at step 912).

In a further embodiment, responsive to a determination that the field of view FOV has two irises positioned therewithin (i.e. irises corresponding to an imaged left eye and an imaged right eye), the method may proceed to steps 1504 to 1508 of FIG. 15, respectively comprising (i) assessing quality of each of the imaged left iris and imaged right iris based on one or more predetermined metrics for iris image quality assessment (step 1504), (ii) responsive to assessed image quality of at least one of the imaged left iris and imaged right iris satisfying at least one predefined criteria, selecting a rule for combining results of iris recognition testing based on the imaged left iris with results of iris recognition testing based on the imaged right iris, which selection is from among a plurality of available rules for combining results (step 1506) and (iii) combining results of iris recognition testing based on the imaged left and right eyes, based on the selected rule and generating a match/non-match decision based on the combined results of iris recognition testing (step 1508). Thereafter, the method reverts to (i) step 908 to check if a match is found, (ii) responsive to no match being found, receives for processing (at step 910) a next image frame from the image sensor, and (iii) subjects the received next image frame to further processing responsive to determining that the received next image frame is sufficiently different from the image frame on which feature extraction and/or comparison was last performed (at step 912).

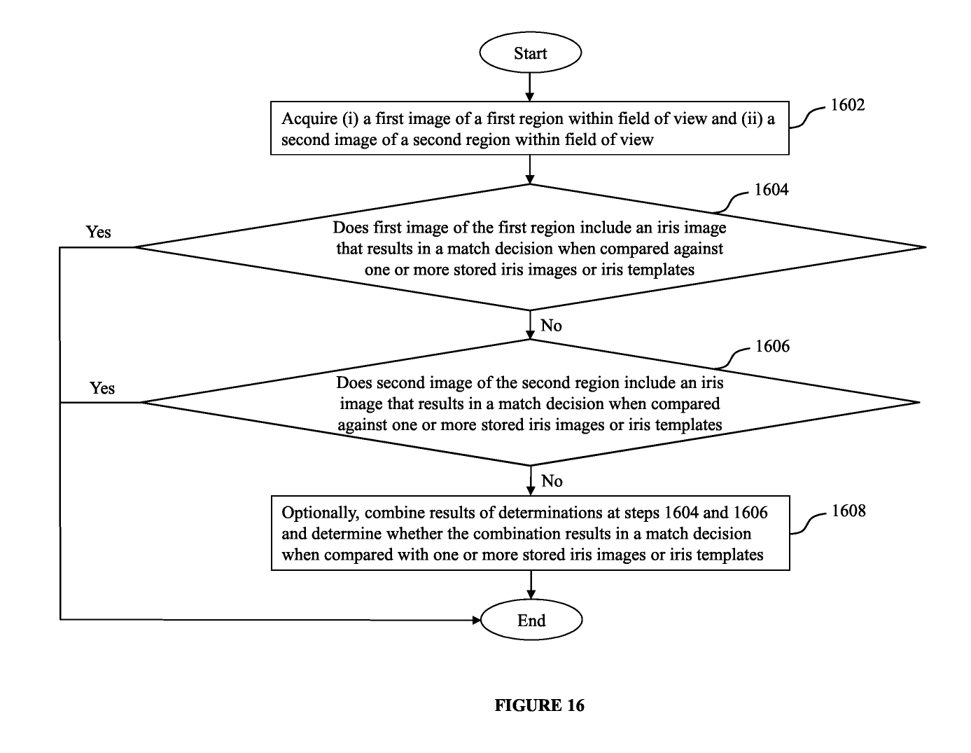

FIG. 16 illustrates another method embodiment of the present invention. Step 1602 comprises acquiring a first image of a first image region within field of view FOV of the iris imaging apparatus, and a second image of a second image region within field of view FOV of the iris imaging apparatus.

It would be understood that the first and second images of the first and second image regions within field of view FOV may be acquired in any number of ways. In an embodiment, step 1602 may comprise acquiring a single image of the entire field of view, and splitting the single image into first and second images, wherein the first image corresponds to a first image region within field of view FOV and the second image corresponds to a second image region within field of view FOV. Another embodiment may involve acquiring a single image of field of view FOV, and treating a first image portion and a second image portion within said single image as virtual first and second images corresponding respectively to a first image region and a second image region within field of view FOV. Another embodiment may involve acquiring a first image of field of view FOV, and using a first image portion from said first image and acquiring a second image of field of view FOV, and using a second image portion from said second image. In yet another embodiment, two image sensors having corresponding optical assemblies may be configured to image two different angular fields of view, which two fields of view together comprise field of view FOV of the imaging apparatus. In this embodiment, the first image sensor acquires a first image corresponding to a first image region within field of view FOV, while the second image sensor acquires a second image corresponding to a second image region within field of view FOV.

Step 1604 comprises determining whether the first image of the first image region within field of view FOV includes an iris image that results in a match decision when compared against one or more stored iris images or iris templates. In the event step 1604 results in a match decision, the method may perform one or more actions triggered by said match decision, and may terminate.

Responsive to a non-match decision (i.e. no match being found) at step 1604, the method proceeds to step 1606, which comprises determining whether the second image of the second image region within field of view FOV includes an iris image that results in a match decision when compared against one or more stored iris images or iris templates. In the event step 1606 results in a match decision, the method may perform one or more actions triggered by said match decision, and may terminate.

It would be understood that the determinations at step 1604 and at step 1606 may include any one or more of the method steps described in FIG. 4, including in any order one or more of receiving an image frame, determining whether the image frame has at least one iris positioned therewithin or whether the image frame meets any other predetermined criteria, performing iris segmentation, performing feature extraction, and comparing extracted features against features corresponding to one or more stored iris images or stored iris templates.

Responsive to a non-match decision (i.e. no match being found) at step 1606 the method may optionally proceed to step 1608, which comprises combining of outputs of processing from steps 1604 and 1606, and determining whether the combined information is sufficient for a match decision. In a preferred embodiment, for each obtained image frame and for each reference template, the outputs of processing from steps 1604 and 1606 are accumulated as evidence in support of a finding regarding similarity or dissimilarity of iris information extracted from the image frame(s) in comparison with one or more stored iris images or stored iris templates, and the method may thereafter in step 1608 render a match or non match decision based on the accumulated evidence. In a specific embodiment of the invention, steps 1602 to 1606 may be repeated until either (i) sufficient evidence has been accumulated to support a match decision or a non match decision in comparison with at least one stored iris image or iris template or (ii) a termination event occurs.

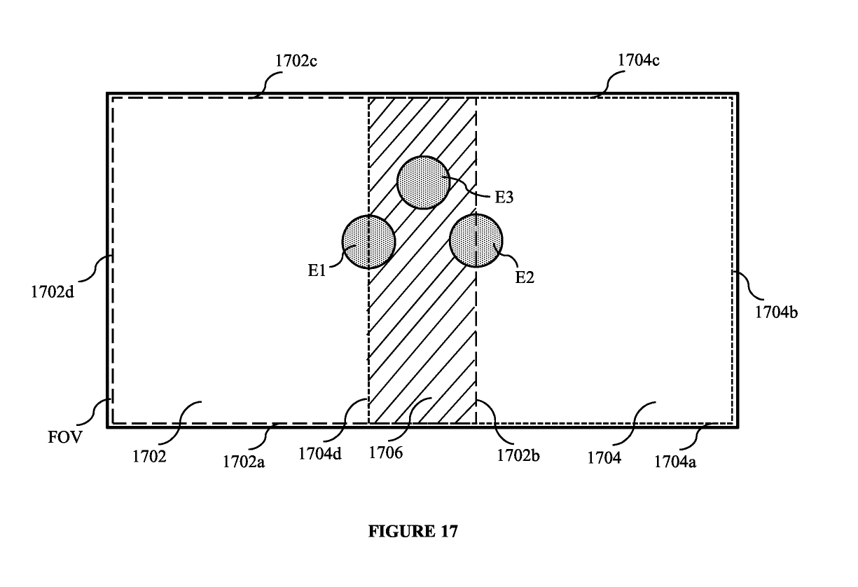

In an embodiment of the above, either the imaging apparatus or the image processing apparatus may be configured such that the first image region and the second image region (and correspondingly, a first image of the first image region and a second image of the second image region) partially overlap so as to define a common overlap region. In the illustration within FIG. 17, first image region 1702 (comprising first image region boundaries 1702a, 1702b, 1702c and 1702d) and second image region 1704 (comprising second image region boundaries 1704a, 1704b, 1704c and 1704d) together comprise the entire field of view FOV of an imaging apparatus.

According to embodiments of the invention, a first image may capture image information corresponding to first image region 1704 within field of view FOV, while a second image may capture image information corresponding to second image region 1702 within field of view FOV. It will be observed that first image region 1702 and second image region 1704 partially overlap, thereby defining common overlap region 1706 (which common overlap region 1706 is defined on the left side by second image region boundary 1704d and on the right side by first image region boundary 1702b). It would be understood that both the first image (corresponding to first image region 1702) and the second image (corresponding to second image region 1704) would capture image information corresponding to common overlap region 1706.

By configuring the imaging apparatus or image processing apparatus appropriately (i.e. to appropriately position and define the boundaries of first image region 1702 and second image region 1704), common overlap region 1706 may be sized to ensure that a subject's iris positioned on either of, or in between image region boundaries 1702b and 1704d (of first image region 1702 and second image region 1704 respectively) would be fully captured within at least one of the first image and the second image—thereby ensuring that a corresponding iris image can be optimally processed for the purpose of iris recognition testing.

By way of example, FIG. 17 illustrates iris E1 positioned on the overlapping left side boundary of second image region 1704. Since E1 is positioned entirely within first image region 1702, an image of E1 would be fully captured within the first image corresponding to first image region 1702. Likewise, FIG. 17 also illustrates the case where iris E2 is positioned on the overlapping right side boundary of first image region 1702. Since E2 is positioned entirely within second image region 1704, an image of E2 would be fully captured within the second image corresponding to second image region 1704. FIG. 17 also illustrates a case where iris E3 is positioned between the overlapping left side boundary 1704d of second image region 1704 and the overlapping right side boundary 1702b of first image region 1702. Since E3 is positioned entirely within the common overlapping region 1706, an image of E3 would be fully captured within (i) the first image corresponding to first image region 1702 and (ii) the second image corresponding to second image region 1704.

In an embodiment of the above, the imaging apparatus or image processing apparatus may be configured such that width (measured in a horizontal direction) of overlapping region 1706 is larger than an iris diameter and smaller than the difference between an inter-pupilary distance and an iris diameter. In another embodiment, the imaging apparatus or image processing apparatus may be configured such that width (measured in a horizontal direction) of overlapping region 1706 is of a dimension sufficient to fully accommodate therewithin, a subject's iris having a size of between 10.2 mm to 13 mm when said iris is positioned within the overlapping region 1706 at an object plane located within depth of field DOF of the iris imaging apparatus.

In a more specific embodiment, the imaging apparatus or image processing apparatus may be configured such that width (measured in a horizontal direction) of overlapping region 1706 is of a dimension sufficient to fully accommodate (with required margins) therewithin, a subject's iris (i) having a size of between 10.2 mm and 13 mm and (ii) that is positioned within overlapping region 1706 at an object plane located substantially at the imaging apparatus facing boundary of depth of field DOF (i.e. at an object plane located located within depth of field DOF and substantially at the shortest image capture distance defined by depth of field DOF).

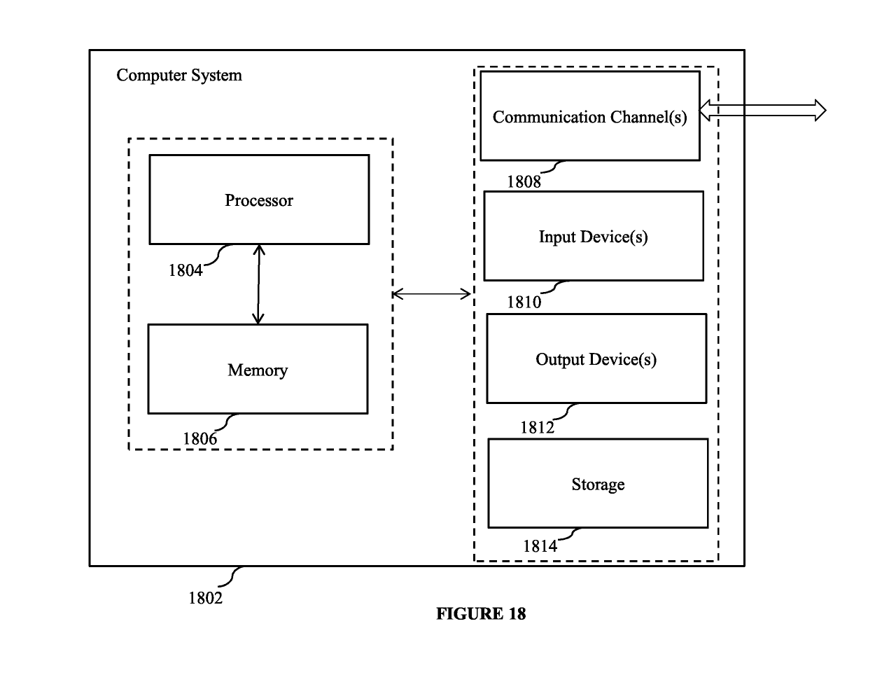

FIG. 18 illustrates an exemplary system in which various embodiments of the invention may be implemented.

The system 1802 comprises at-least one processor 1804 and at-least one memory 1806. The processor 1804 executes program instructions and may be a real processor. The processor 1804 may also be a virtual processor. The computer system 1802 is not intended to suggest any limitation as to scope of use or functionality of described embodiments. For example, the computer system 1802 may include, but not limited to, one or more of a general-purpose computer, a programmed microprocessor, a micro-controller, an integrated circuit, and other devices or arrangements of devices that are capable of implementing the steps that constitute the method of the present invention. In an embodiment of the present invention, the memory 1806 may store software for implementing various embodiments of the present invention. The computer system 1802 may have additional components. For example, the computer system 1802 includes one or more communication channels 1808, one or more input devices 1810, one or more output devices 1812, and storage 1814. An interconnection mechanism (not shown) such as a bus, controller, or network, interconnects the components of the computer system 1802. In various embodiments of the present invention, operating system software (not shown) provides an operating environment for various softwares executing in the computer system 1802, and manages different functionalities of the components of the computer system 1802.

The communication channel(s) 1808 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 1810 may include, but not limited to, a touch screen, a keyboard, mouse, pen, joystick, trackball, a voice device, a scanning device, or any another device that is capable of providing input to the computer system 1802. In an embodiment of the present invention, the input device(s) 1810 may be a sound card or similar device that accepts audio input in analog or digital form. The output device(s) 1812 may include, but not limited to, a user interface on CRT or LCD, printer, speaker, CD/DVD writer, LED, actuator, or any other device that provides output from the computer system 1802.

The storage 1814 may include, but not limited to, magnetic disks, magnetic tapes, CD-ROMs, CD-RWs, DVDs, any types of computer memory, magnetic stipes, smart cards, printed barcodes or any other transitory or non-transitory medium which can be used to store information and can be accessed by the computer system 1802. In various embodiments of the present invention, the storage 1814 contains program instructions for implementing the described embodiments.

While not illustrated in FIG. 18, the system of FIG. 18 may further include some or all of the components of an imaging apparatus of the type more fully described in connection with FIG. 1 hereinabove.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1802. The method described herein is typically implemented as a computer program product, comprising a set of program instructions which is executed by the computer system 1802 or any other similar device. The set of program instructions may be a series of computer readable codes stored on a tangible medium, such as a computer readable storage medium (storage 1814), for example, diskette, CD-ROM, ROM, flash drives or hard disk, or transmittable to the computer system 1802, via a modem or other interface device, over either a tangible medium, including but not limited to optical or analogue communications channel(s) 1808, or implemented in hardware such as in an integrated circuit. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for iris based biometric recognition, comprising the steps of:
(a) receiving a first image of a first image region within a field of view of an imaging apparatus;
(b) receiving a second image of a second image region within the field of view of the imaging apparatus;
(c) performing a first determination comprising determining whether image information extracted from the first image matches stored iris information corresponding to at least one iris; and
(d) responsive to the first determination rendering a non-match decision, performing a second determination comprising determining whether image information extracted from the second image matches the stored iris information.

2. The method for iris based biometric recognition as claimed in claim 1, wherein responsive to the second determination rendering a non-match decision in comparison with the stored iris information:
combining outputs of the first determination and the second determination based on a method for combining outputs; and
rendering a match decision or a non-match decision based on an output of the combining of outputs.

3. The method for iris based biometric recognition as claimed in claim 1, wherein the first image region and the second image region are positioned to partially overlap each other.

4. The method for iris based biometric recognition as claimed in claim 3, wherein overlap between the first image region and the second image region defines a common overlap region having horizontal width of at least 300 pixels.

5. The method for iris based biometric recognition as claimed in claim 3, wherein overlap between the first image region and the second image region defines a common overlap region such that horizontal width of the common overlap region is of a dimension sufficient to fully accommodate an iris positioned within the common overlap region at an object plane located within a depth of field of the imaging apparatus.

6. The method for iris based biometric recognition as claimed in claim 5, wherein the object plane is located at a shortest image capture distance defined by the depth of field of the imaging apparatus.

7. A computer program product for iris based biometric recognition, comprising a computer usable medium having a computer readable program code embodied therein, the computer readable program code comprising instructions for:
(a) receiving a first image of a first image region within a field of view of an imaging apparatus;
(b) receiving a second image of a second image region within the field of view of the imaging apparatus;
(c) performing a first determination comprising determining whether image information extracted from the first image matches stored iris information corresponding to at least one iris; and
(d) responsive to the first determination rendering a non-match decision, performing a second determination comprising determining whether image information extracted from the second image matches the stored iris information.

8. A system for iris based biometric recognition, comprising:
at least one image sensor; and
a processing device configured for:
(a) receiving a first image of a first image region within a field of view of an imaging apparatus;
(b) receiving a second image of a second image region within the field of view of the imaging apparatus;
(c) performing a first determination comprising determining whether image information extracted from the first image matches stored iris information corresponding to at least one iris; and
(d) responsive to the first determination rendering a non-match decision, performing a second determination comprising determining whether image information extracted from the second image matches the stored iris information.

9. A method for iris based biometric recognition, comprising the steps of:
(a) receiving an image from an image sensor of an imaging apparatus;
(b) accumulating evidence in support of similarity and/or dissimilarity of the iris information from the image in step (a) in comparison with at least one stored iris template; and
(c) repeating steps (a) and (b) until sufficient evidence is accumulated to support either a match decision or a non-match decision with reference to at least one stored iris template or until occurrence of a termination event.
